(19) United States
(12) Patent Application Publication
(10) Pub. No.: US 2016/0292108 A1
(43) Pub. Date: Oct. 6, 2016

(54) INFORMATION PROCESSING DEVICE, CONTROL PROGRAM FOR INFORMATION PROCESSING DEVICE, AND CONTROL METHOD FOR INFORMATION PROCESSING DEVICE

(71) Applicant: FUJITSU LIMITED, Kawasaki-shi (JP)

(72) Inventors: Yotaro Konishi, Yokohama (JP); Mitsuru SATO, Machida (JP)

(73) Assignee: FUJITSU LIMITED, Kawasaki-shi (JP)

(21) Appl. No.: 15/070,015

(22) Filed: Mar. 15, 2016

(30) Foreign Application Priority Data
Apr. 6, 2015 (JP) 2015-077459

(51) Int. Cl. G06F 13/366; G06F 13/40; G06F 9/455

(52) U.S. Cl. CPC G06F 13/366; G06F 9/45558; G06F 13/4068; G06F 2009/45579

(57) ABSTRACT

An information processing device includes an input and output unit to which an input/output device is able to be connected, an information holding unit that registers identification information of a monitoring target input/output device which is not compatible with an error suppression function of suppressing propagation of errors occurring when the input/output device is disconnected from the input and output unit, an execution unit that executes an individual program using infrastructure software, and a determining unit that, by executing the infrastructure software and the individual program, when an access to a first area of the monitoring target input/output device is detected, detects that a value read from a second area of the monitoring target input/output device is an abnormal value as a result of determining whether the value read from the second area is a predetermined value.

### CROSS-REFERENCE TO RELATED APPLICATION

This application is based upon and claims the benefit of priority of the prior Japanese Patent Application No. 2015-77459, filed on Apr. 6, 2015, the entire contents of which are incorporated herein by reference.

### FIELD

The present invention relates to an information processing device, a control program for the information processing device, and a control method for the information processing device.

### BACKGROUND

An information processing device has a central processing unit (CPU) and a memory, and the CPU executes instructions of a program in the memory to realize the function of the program. Further, the information processing device has an input/output (I/O) bus, and various I/O devices (or peripheral devices) (for example, a peripheral component such as a hard disk or a flash memory) are connected to the I/O bus via an I/O bus bridge (or an input/output unit, an I/O switch, or an I/O interface). Moreover, the information processing device has a device driver that is provided in the OS so as to drive the I/O device, and the CPU accesses a device via the device driver in the OS.

When an I/O device connected to the I/O bus bridge fails or is removed in an active state, an unrecoverable error event such as a disconnect detection event occurs and the error event propagates from the I/O bus bridge to the CPU, which may result in a system shutdown.

In order to avoid the system shutdown caused by such an error, a downstream port containment (DPC) is employed as an additional specification of the peripheral component interconnect express (PCIe). A bus bridge having the DPC function confines an error event generated in a bus bridge port so as not to propagate upstream the CPU and the like to prevent a system' shutdown due to errors and to enable a continuous operation of the system. In this way, the reliability of the bus is enhanced.

On the other hand, an application program accesses an interface such as a device object of the OS and accesses an I/O device connected to an I/O bus bridge via the device driver in the OS. In this case, for example, when an abnormality such as removal of the I/O device from the I/O bus bridge occurs in the I/O device, an OS interrupt occurs, and the OS removes the device object and disables subsequent accesses to the I/O device.

Here, an access to the I/O device may occur at a point in time before the OS completes removal of the device object and immediately after an abnormality such as removal of the I/O device occurred. In general, the bus bridge of the I/O bus such as a PCIe bus sends ALL “F” data such as 0xFFFF_FFFF, for example, in response to the access to the I/O device that is not connected. Upon receiving such ALL “F” data, a DPC-compatible device driver which has the DPC function executes appropriate error processing to avoid a wrong memory access based on the ALL “F” data and prevent the system from entering an indefinite state (see Japanese Patent Application Publication No. 2011-100431, Japanese Patent Application Publication No. 2011-197845, and Japanese Patent Application Publication No. 2011-123857, for example).

### SUMMARY

However, a DPC-incompatible device driver may handle the ALL “F” data as normal data and does not perform appropriate error processing but generates a wrong memory access which may destroy data and cause the system to enter an indefinite state. Moreover, since the function of the device driver depends on a device vender, it is difficult to guarantee that all device drivers are compatible with the DPC function.

One aspect of the disclosure is an information processing device that includes an input and output unit to which an input/output device is able to be connected, an information holding unit that registers identification information of a monitoring target input/output device which is not compatible with an error suppression function of suppressing propagation of errors occurring when the input/output device is disconnected from the input and output unit, an execution unit that executes an individual program using infrastructure software, and a determining unit that, by executing the infrastructure software and the individual program, when an access to a first area of the monitoring target input/output device is detected, detects that a value read from a second area of the monitoring target input/output device is an abnormal value as a result of determining whether the value read from the second area is a predetermined value.

According to the aspect, the occurrence of deficiency errors due to device abnormalities is suppressed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing the function of downstream port containment (DPC) of PCIe;

FIG. 2 is a diagram illustrating an operation when an I/O device is removed from an I/O bus bridge;

FIG. 3 is a diagram illustrating a configuration of an information processing device according to a first embodiment;

FIG. 4 is a diagram illustrating an example of a monitoring target I/O device table;

FIG. 5 is a flowchart illustrating the process during activation of the information processing device 1 according to the present embodiment;

FIG. 6 is a flowchart illustrating an operation of accessing a monitoring target I/O device by the information processing device 1 according to the present embodiment;

FIG. 7 is a diagram illustrating a configuration of the information processing device 1 according to the second embodiment;

FIG. 8 is a diagram illustrating a configuration example of a virtual machine of the information processing device 1 according to the second embodiment;

FIG. 9 is a diagram illustrating a configuration example such as program modules and tables of the hypervisor;

FIG. 10 is a diagram illustrating a configuration example of a VM control structure (VMCS);

FIG. 11 is a diagram illustrating an example of respective tables in the virtual machine information file 280 of FIG. 9;

FIG. 12 is a diagram illustrating a hardware configuration corresponding to virtualization of the CPU according to the present embodiment;

FIG. 13 is a diagram illustrating a configuration example of a BAR register;

FIGS. 14 and 15 are flowcharts illustrating an outline of the operation of the information processing device according to the second embodiment;

FIG. 16 is a flowchart illustrating an outline of a process before activation of the virtual machine VM and the process when VM_Exit occurs after VM_Entry occurred;

FIG. 17 is a flowchart of the I/O port process S50 in the HV mode;

FIG. 18 is a flowchart of the I/O write process S58 included in the I/O port process S50 in the HV mode;

FIG. 19 is a flowchart of the write process S64 on the configuration area of the monitoring target I/O device;

FIG. 20 is a flowchart of the I/O write process S66 in the non-initialization process in FIG. 18;

FIG. 21 is a flowchart of the I/O read process S57 in FIG. 17;

FIG. 22 is a flowchart of the MMIO process S49 in the HV mode;

FIG. 23 is a flowchart of the MMIO write process S100 and the MMIO read process S99 included in the MMIO process S49 in the HV mode;

FIG. 24 is a flowchart of the read result error checking process S88 in FIGS. 21 and 23; and

FIG. 25 is a flowchart of a modification of the I/O write process in FIG. 18.

### DESCRIPTION OF EMBODIMENTS

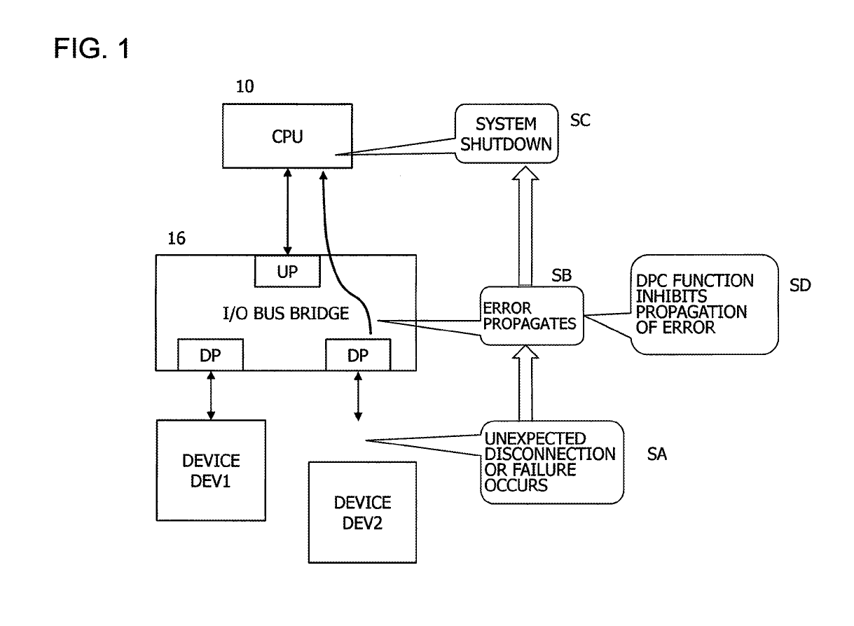

FIG. 1 is a diagram for describing the function of downstream port containment (DPC) of PCIe. FIG. 1 illustrates a state in which an I/O device DEV1 is connected to a downstream port DP of an I/O bus bridge 16 and an I/O device DEV2 is removed from a downstream port DP. When the device DEV2 connected to the I/O bus bridge 16 which does not have a DPC function is removed (step SA), an unrecoverable fatal error propagates through the I/O bus bridge 16 (step SB) to a CPU 10, which may result in a system shutdown (step SC).

An I/O bus bridge 16 having a DPC function prevents propagation of an error occurring due to removal of the device DEV2 from the I/O bus bridge 16 (step SD). Specifically, the I/O bus bridge 16 changes the fatal error to a correctable error by lowering the degree of the error and allows the error to propagate upstream.

In this way, it is possible to avoid the occurrence of a system shutdown resulting from errors caused by device abnormalities. As a result, the reliability of the I/O bus is enhanced. Recent I/O devices include a device such as a flash memory which is frequently inserted and removed. Thus, it is desirable to prevent a system shutdown resulting from removal of such a device from an I/O bus bridge.

On the other hand, an application program accesses an interface such as a device object of the OS and accesses an I/O device connected to an I/O bus bridge 16 via the device driver in the OS. In this case, for example, when an abnormality such as removal of the I/O device from the I/O bus bridge occurs in the I/O device, an OS interrupt occurs, and the OS removes the device object and disables subsequent accesses to the I/O device.

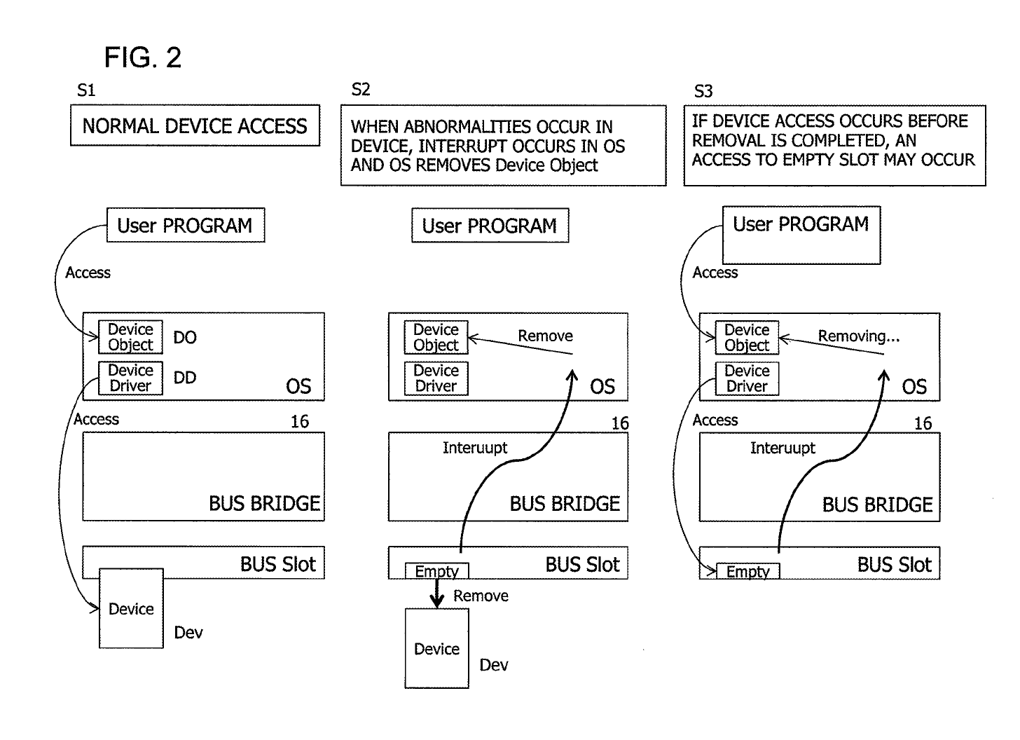

FIG. 2 is a diagram illustrating an operation when an I/O device is removed from an I/O bus bridge. In a normal device access S1 illustrated on the left side of FIG. 2, when a user program accesses an I/O device Dev, the user program accesses a device object DO in an operating system OS to execute a device driver DD in the OS via the device object.

According to the operation S2 performed when an abnormality occurs in a device Dev, illustrated at the center of FIG. 2, when a device Dev is removed from the bus bridge 16, an interrupt occurs in the OS via the bus bridge 16 and the OS removes the device object DO.

However, according to the operation S3 illustrated on the right side of FIG. 2, in a period in which the OS is removing the device object DO by an interrupt process (before completion of the removal) after the device is removed, the user program may access the removed I/O device via the device object DO. Specifically, the access to the I/O device is an access to a register of the device.

For example, according to the PCIe specification, the I/O bus bridge 16 sends ALL “F” data (0xFFFF_FFFF) in response to a read access to a slot in which an I/O device is not present. This is because the I/O bus bridge port is pulled up to a power supply voltage, and ALL “F” data is generated unless a device is connected thereto.

Here, a device driver of a DPC-compatible I/O device regards the ALL “F” data as a wrong value and does not perform wrong reference or the like of a memory. A system shutdown does not occur due to the DPC function even when a device is removed unexpectedly. The DPC-compatible device driver is designed by taking the possibility of the wrong access into consideration.

However, a device driver of a DPC-incompatible device is not able to regard ALL “F” data as a wrong value but continues processes, which may result in wrong reference or the like to a memory, and in worst cases, may result in destruction of data and the system falling into an indefinite state.

Thus, it is desirable to prevent the occurrence of an unexpected error resulting from such a device error as illustrated in FIG. 2 even when an abnormality occurs in an I/O device.

### First Embodiment

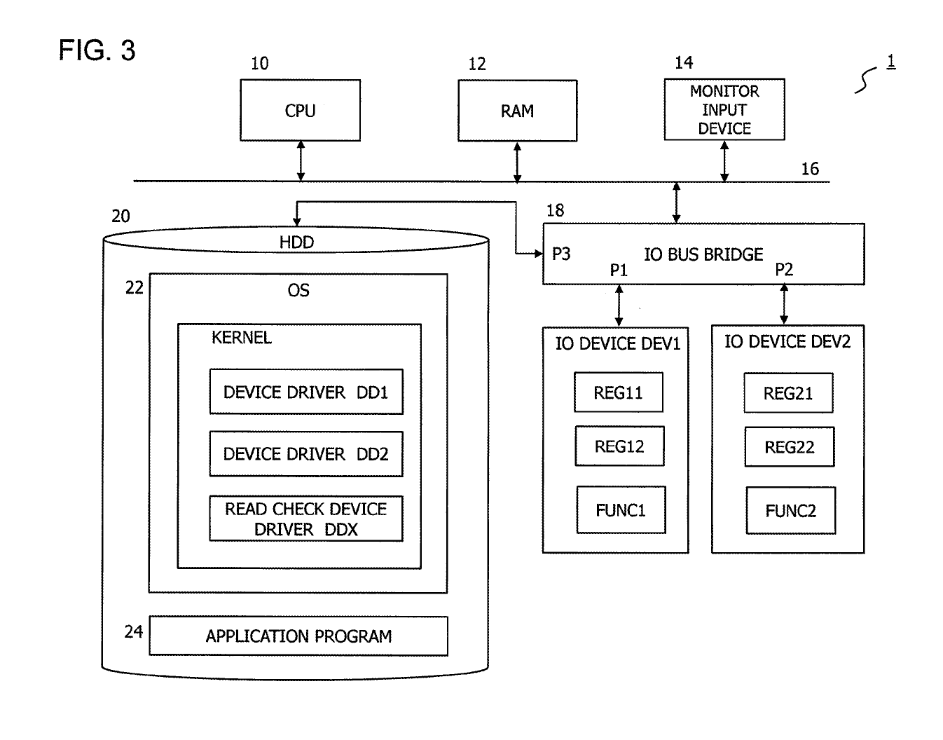

FIG. 3 is a diagram illustrating a configuration of an information processing device according to a first embodiment. An information processing device 1 is a computer or a server. The information processing device 1 includes a central processing unit (CPU) 10 which is an information processing circuit, a main memory 12, an input output device 14 such as a monitor or a keyboard, and a CPU bus 16 that connects these components. Further, the information processing device 1 includes an I/O bus bridge (or an input and output unit) 18 connected to the CPU bus 16 and I/O devices (or peripheral devices) DEV1 and DEV2 are connected to I/O ports P1 and P2 of the I/O bus bridge 18 respectively. Moreover, a large-volume storage device 20 such as a hard disk which is one of I/O devices is connected to an I/O port P3 of the I/O bus bridge 18.

The I/O bus bridge 18 has a DPC function of allowing a fatal error when an abnormal state such as removal of the I/O devices DEV1 and DEV2 occurs to propagate toward the upstream side as a correctable error by lowering an error degree. Moreover, the I/O devices DEV1 and DEV2 each have a register group REG11-12, REG21-22 that the CPU 10 accesses and a functional circuit or a functional device FUNC that realizes the function of a device.

The hard disk 20 stores an application program (or an individual program) 24 and an operating system (OS) (or an infrastructure software) 22, for example. When the information processing device 1 is activated, the information processing device 1 loads the application program 24 and the OS 22 into the main memory 12 and the CPU 10 executes the application program and the OS loaded into the main memory 12.

A kernel of the OS 22 has device drivers DD1 and DD2 which are device control programs that control at least the I/O devices DEV1 and DEV2, respectively. Further, in the present embodiment, the kernel of the OS 22 has a read check device driver DDX that checks whether a read access destination is a monitoring target I/O device when a read system call occurs and checks whether the I/O device is connected properly or is in a normal state if the read is addressed to a monitoring target I/O device.

The CPU 10 executes the application program 24 and the OS to access the I/O device DEV1 or DEV2 to cause the functional circuit or the functional device FUNC of the I/O device to execute a desired process. Specifically, when an access to an I/O device occurs during execution of the application program 24 by the CPU 10, the CPU 10 operates access target device driver DD1 or DD2 with the aid of a device object (not illustrated) in the OS to cause the device drivers to write predetermined setting values to the registers in the I/O device DEV1 or DEV2 so that the functional circuit or the functional device FUNC executes processes corresponding to the setting values.

The information processing device 1 of the present embodiment registers a DPC-incompatible I/O device among I/O devices mounted on the I/O bus bridge as a monitoring target device so that such an error as the operation S3 described in FIG. 2 does not occur. Moreover, when the OS receives a read system call, the information processing device 1 operates the read check device driver DDX. The read check device driver DDX detects whether the read is an access to a monitoring target device. When the read is not an access to the monitoring target device, the OS executes the read process.

When the read is an access to the monitoring target device, the read check device driver DDX reads the value of a predetermined register of an access target I/O device and checks whether the access target I/O device is in an abnormal state such as being disconnected from the I/O bus bridge. When the access target I/O device is in an abnormal state, an operation of the device driver of the access target I/O device is inhibited and an access to the access target I/O device is suppressed. On the other hand, when the access target I/O device is not in the abnormal state, the operation of the device driver of the access target I/O device is started and an access to the access target I/O device is executed.

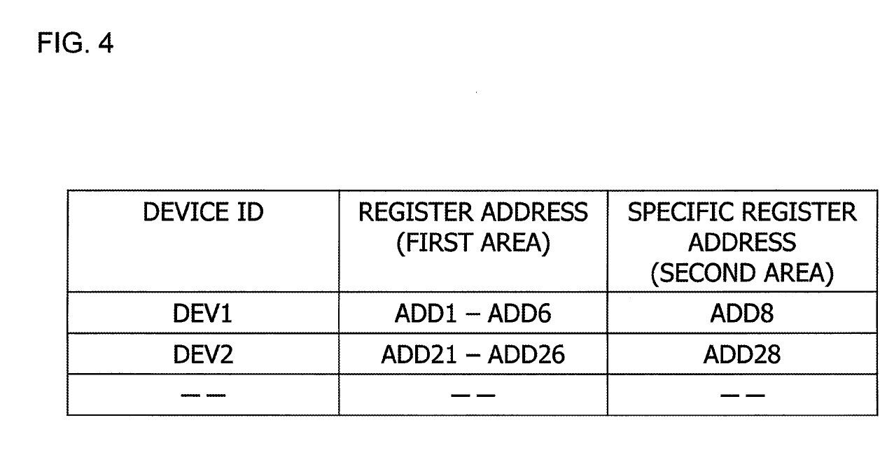

FIG. 4 is a diagram illustrating an example of a monitoring target I/O device table. DPC-incompatible I/O devices are registered in a monitoring target I/O device table 270 illustrated in FIG. 4. Further, an address (a first area) of the register of a monitoring target I/O device is also registered to detect an access to the monitoring target I/O device. The first area of the device DEV1 includes six register addresses ADD1-ADD6 for example. Moreover, an address (a second area) of a specific register in the monitoring target I/O device is also registered. The specific register is a register that guarantees that data, that is not an abnormal value that an I/O bus bridge sends as a response when the I/O device is in an abnormal state, is stored in the specific register. For example, a register in which a vender ID or a product ID of a configuration space of an I/O device is stored is selected.

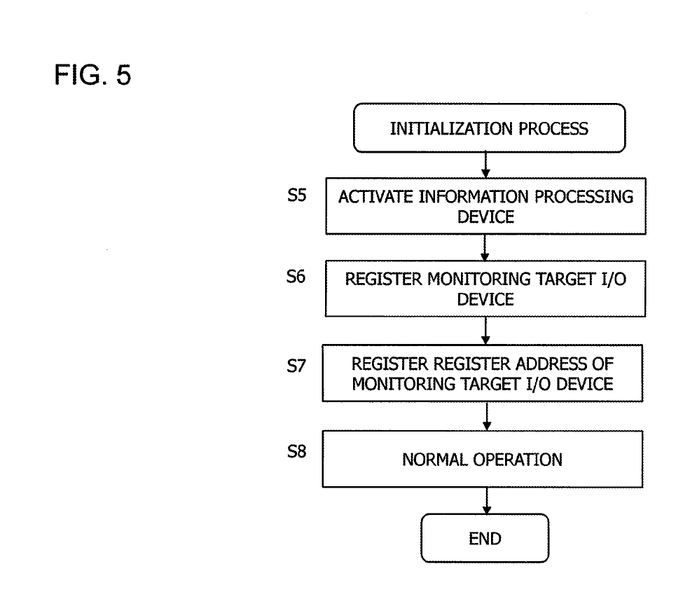

FIG. 5 is a flowchart illustrating the process during activation of the information processing device 1 according to the present embodiment. First, the information processing device 1 is activated (S5). During an initialization operation of the device, the information processing device 1 registers a DPC-incompatible I/O device in the monitoring target I/O device table (S6). For example, identification information unique to a monitoring target I/O device is registered in the monitoring target I/O device table.

Subsequently, the information processing device 1 acquires the address (the first area) of the register of the monitoring target I/O device from a base address register (BAR) in the I/O device and registers the address in the first area of the monitoring target I/O device table 270 (S7). Further, the information processing device 1 also registers the address of a specific register in the address (the second area) of the specific register in the monitoring target I/O device table 270 in FIG. 4 (S7). After that, the information processing device 1 performs a normal operation and the CPU 10 executes the application program 24, for example.

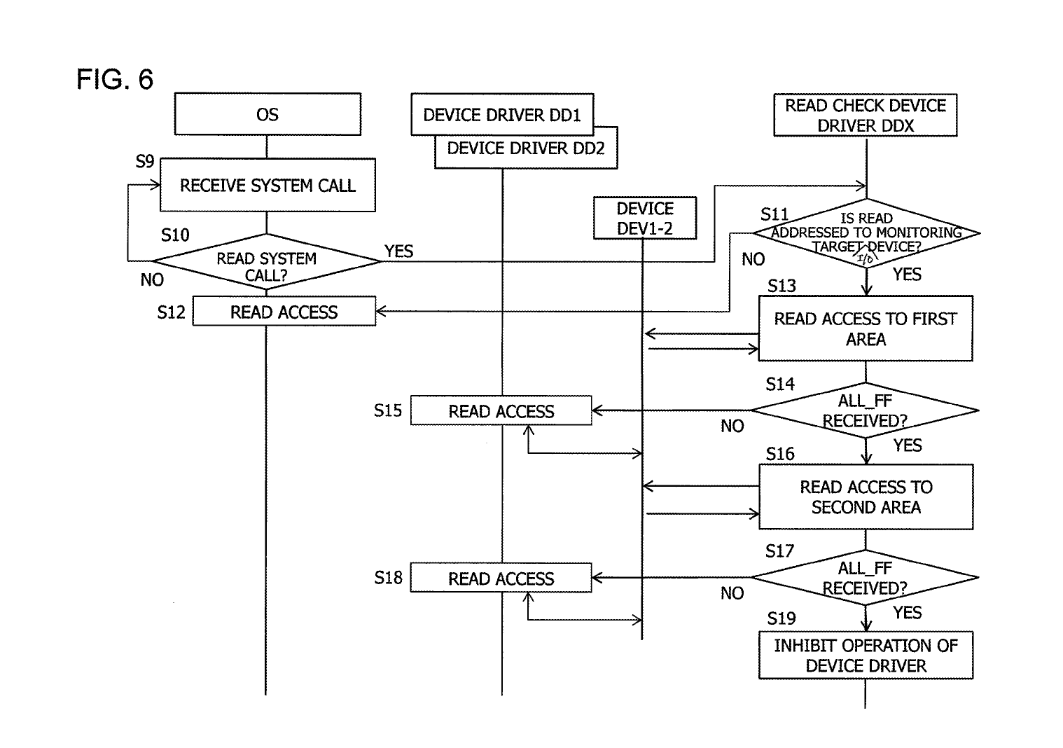

FIG. 6 is a flowchart illustrating an operation of accessing a monitoring target I/O device by the information processing device 1 according to the present embodiment. FIG. 6 illustrates the operations of the OS, the device drivers DD1 and DD2, and the read check device driver DDX.

The CPU 10 executes the application program 24 according to a normal operation and executes a read access as needed. In response to this, the application program 24 issues a read system call to the OS. The OS receives the system call (S9) and starts the operation of the read check device driver DDX when the system call is a read system call (S10: YES).

In response to this, the read check device driver DDX checks whether the access destination of the read is a monitoring target I/O device (S11). When the read is not addressed to the monitoring target I/O device (S11: NO), the OS executes the read system call (S12).

On the other hand, when the read is addressed to the monitoring target I/O device, the read check device driver DDX executes a read access to the access destination address (the address in the first area) of the I/O device (S13) and checks whether the read data is ALL “F” (S14). When the access destination I/O device is removed (disconnected or in a non-connection state) from the port of the bus bridge, the bus bridge generally sends ALL “F” data as a response. If the read data is not ALL “F” (S14: NO), since the access destination I/O device is not in an abnormal state where the I/O device is removed, the read check device driver DDX causes the device drivers DD1 and DD2 of the access destination I/O device to start or continue the read operation(S15). On the other hand, if the read data is ALL “F” (S14: YES), the read check device driver DDX executes a read access to the register of the second area of the access destination I/O device (S16). That is, since there is a possibility that the read data of ALL “F” is a normal register value, a register value in the second area that always contains a “0”-bit is read and it is checked whether the read data is ALL “F”.

When the read data is not ALL “F” (S17: NO), since the access destination I/O device is not in the abnormal state where the access destination I/O device is removed, the read check device driver DDX causes the device drivers DD1 and DD2 of the access destination I/O device to start or continue the read operation (S18). On the other hand, when the read data is ALL “F” (S17: YES), the read check device driver DDX inhibits the operation of the device driver of the access destination I/O device and suppresses a read access to the I/O device (S18).

Even when the read check device driver DDX receives read data of ALL “F” as a result of a read access to the I/O device, the read check device driver DDX does not perform any operation of executing a wrong memory access to change data or putting the system into an indefinite state in response to this. The read check device driver DDX does not send the read data, ALL “F”, to the CPU as a response but only checks whether the read is addressed to the monitoring target I/O device and whether the read data from the access destination I/O device is ALL “F”.

In contrast, when normal device drivers DD1 and DD2 receive read data of ALL “F” as a result of a read access to the I/O device, there is a possibility that the device drivers DD1 and DD2 process the read data to perform any wrong process. This is because the function of the device driver depends on a device vender. And, some device driver may not correspond to the DPC function.

As a modification, the read check device driver DDX may omit the processes S13 and S14 of executing a read access to the first area among the processes illustrated in FIG. 6. In this case, when it is detected that the read is addressed to the monitoring target I/O device (S11: YES), the read check device driver DDX executes a read access to the second area (S16) and determines whether the read data is ALL “F” (S17). If the read data is ALL “F,” since an I/O device is in an abnormal state, a subsequent read access to the first address by the device driver is suppressed.

As described above, in the information processing device 1 of the first embodiment, when the OS receives a read system call, first, the read check device driver DDX checks whether the access destination is a monitoring target I/O device. Further, when the access destination is the monitoring target I/O device, the read check device driver executes a read access to the second address of the access destination I/O device and checks whether the access destination I/O device is in an abnormal state based on the read data. When the access destination I/O device is in a normal state, an access process of a device driver corresponding to the access destination I/O device is executed. When the access destination I/O device is in an abnormal state, the access of the device driver is suppressed or inhibited.

Thus, according to the first embodiment, even when an inappropriate access to the DPC-incompatible I/O device in the abnormal state occurs, a memory is suppressed from being rewritten inappropriately and the system is suppressed from entering an indefinite state.

### Second Embodiment

An information processing device of a second embodiment executes a hypervisor which is a virtualization control program to generate virtual machines (guest VMs) and the generated virtual machines execute application programs in cooperation with the respective guest OSs. The hypervisor generates the respective virtual machines by allocating hardware resources (a CPU, a main memory, a disk storage device, and a network device) of the information processing device based on the specifications (the number of CPUs or CPU cores, a CPU clock frequency, a memory size, a disk size, a network bandwidth, and the like) of the respective virtual machines. In general, a host OS includes the hypervisor.

In the second embodiment, when an access to a DPC-incompatible I/O device by a virtual machine occurs, and the I/O device is in an abnormal state, the hypervisor performs abnormality processing to suppress an inappropriate operation of a DPC-incompatible device driver. In this way, functional deficiency of the DPC-incompatible device driver is compensated so that such an abnormal operation as illustrated in FIG. 2 does not occur even when an access to an I/O device in an abnormal state occurs.

Technologies related to the second embodiment are summarized in Section [Related Technologies] at the end of this specification. Thus, the following description may be understood when the section is referenced appropriately.

### Information Processing Device and Virtual Machine of Second Embodiment

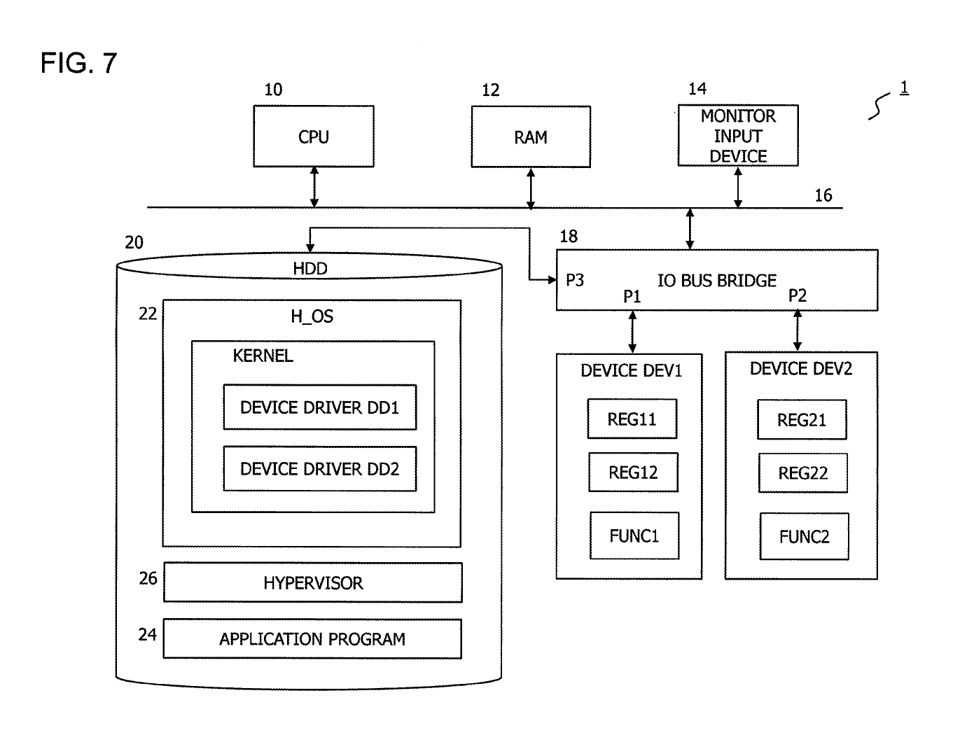

FIG. 7 is a diagram illustrating a configuration of the information processing device 1 according to the second embodiment. Similarly to FIG. 3, the information processing device 1 is a computer or a server. The information processing device 1 includes a central processing unit (CPU) 10 which is an information processing circuit, a main memory 12, an input output device 14 such as a monitor or a keyboard, and a CPU bus 16 that connects these components. Further, the information processing device 1 includes an I/O bus bridge (or an input and output unit) 18 connected to the CPU bus 16, and I/O devices (or peripheral devices) DEV1 and DEV2 are connected to I/O ports P1 and P2 of the I/O bus bridge 18. Moreover, a large-volume storage device 20 such as a hard disk which is one of I/O devices is connected to an I/O port P3 of the I/O bus bridge 18.

The I/O bus bridge 18 has a DPC function of allowing a fatal error when an abnormal state such as removal of the I/O devices DEV1 and DEV2 occurs to propagate toward the upstream side as a correctable error by lowering an error degree. Moreover, the I/O devices DEV1 and DEV2 each have a register group REG11-12, REG21-22 that the CPU 10 accesses and a functional circuit or a functional device FUNC that realizes the function of a device.

The hard disk 20 stores an application program (OS) (or an individual program) 24 and an operating system (or an infrastructure software) 22, for example. When the information processing device 1 is activated, the information processing device 1 loads the application program 24 and the OS 22 into the main memory 12 and the CPU 10 executes the application program and the OS loaded into the main memory 12.

A kernel of the OS 22 has device drivers DD1 and DD2 which are device control programs that control at least the I/O devices DEV1 and DEV2, respectively.

The CPU 10 executes the application program 24 and the OS to access the I/O device DEV1 or DEV2 to cause the functional circuit or the functional device FUNC of the I/O device to execute a desired process.

Specifically, when an access to an I/O device occurs during execution of the application program 24 by the CPU 10, the CPU 10 operates access target device driver DD1 or DD2 with the aid of a device object (not illustrated) in the OS to cause the device drivers to write predetermined setting values to the registers in the I/O device DEV1 or DEV2 so that the functional circuit or the functional device FUNC executes processes corresponding to the setting values. The above-described configuration is the same as that illustrated in FIG. 3.

Unlike FIG. 3, the information processing device 1 illustrated in FIG. 7 has a hypervisor (or infrastructure software) 26 that generates and controls virtual machines. When the hypervisor 26 activates a virtual machine and the virtual machine executes the application program 24, the hypervisor 26 controls allocation of hardware resources to the virtual machine. The hypervisor 26 is generally included in the OS 22.

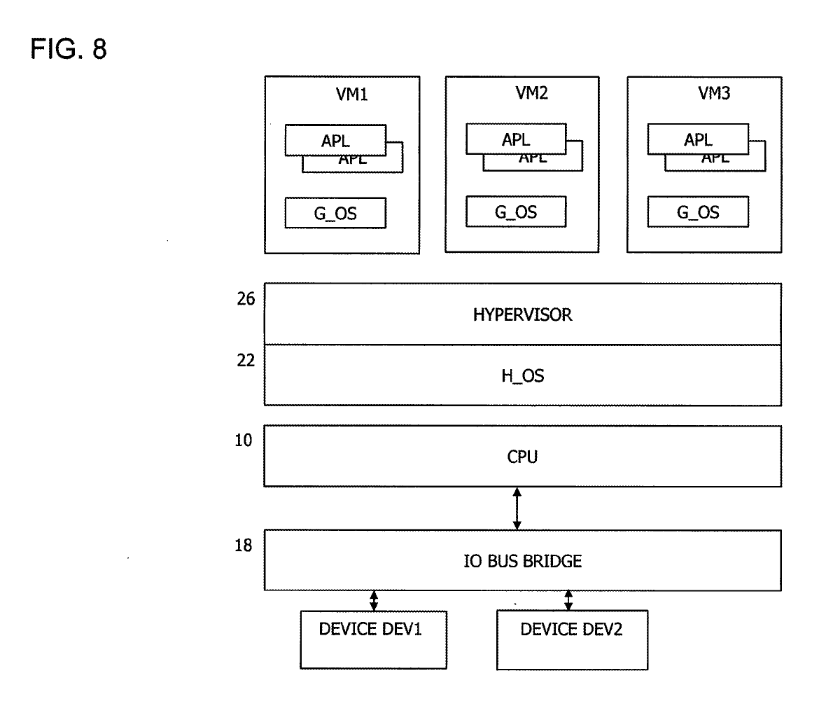

FIG. 8 is a diagram illustrating a configuration example of a virtual machine of the information processing device 1 according to the second embodiment. In the example of FIG. 8, the hypervisor 26 generates and operates three virtual machines VM1, VM2, and VM3. A guest OS G_OS and an application program APL are installed in each of the corresponding virtual machines VMs. The CPU 10 executes the application program APL of each virtual machine VM in cooperation with the guest OS G_OS under the control of the hardware resource allocation control of the hypervisor 26. When the virtual machine VM requests an access to the I/O devices DEV1 and DEV2, a device driver in the host OS 22 executes an access via the hypervisor 26.

The information processing device 1 of the second embodiment registers a DPC-incompatible I/O device among the I/O devices mounted on the I/O bus bridge as a monitoring target device so that such an error as the operation S3 in FIG. 2 does not occur. In other words, the DPC-incompatible I/O device means an I/O device of a DPC-incompatible device driver. Various setting are made so that an operation mode transitions from a virtual machine operation mode (hereinafter a VM mode) to a hypervisor operation mode (hereinafter a HV mode) when an access to a monitoring target I/O device occurs during execution of the application program APL by the virtual machine VM.

When an access to a monitoring target I/O device occurs in VM mode, the operation mode transitions to the HV mode and the hypervisor 26 accesses the access target I/O device and checks whether the read data is an abnormal value instead of the device driver. When the read data is an abnormal value (the ALL “F,” for example), the hypervisor 26 determines that the access is a wrong access and stops the target virtual machine VM. In this way, the access to the I/O device by the target virtual machine VM is stopped, and as a result, the access is suppressed. On the other hand, when the read data is not an abnormal value, the hypervisor determines that the access is a normal access, stores the read data in the memory or the register of the virtual machine, and the operation mode transitions to a virtual machine operation mode (the VM mode).

In the second embodiment, a hypervisor operation mode (the HV mode) and a virtual machine operation mode (the VM mode) are used. The operation mode transitions to the HV mode in response to an access request (specifically, a read access request) to a DPC-incompatible I/O device by the virtual machine during MV mode, and the hypervisor emulates the access (the read access) to the I/O device and checks whether the I/O device is in an abnormal state based on the read data. When the I/O device is not in the abnormal state, the operation mode transitions to the VM mode. However, since the hypervisor has finished emulation of the read operation, the process of the device driver accessing the I/O device is not performed. As explained above, when an access to the DPC-incompatible I/O device occurs, the hypervisor executes the access and checks the abnormal state on a realtime basis.

### Hypervisor

Next, a configuration example of the hypervisor according to the present embodiment, a CPU configuration, and a register of the I/O device will be described. Based on these descriptions, an initialization operation of the information processing device 1 and an operation of the device 1 when an access to the monitoring target I/O device occurs will be described.

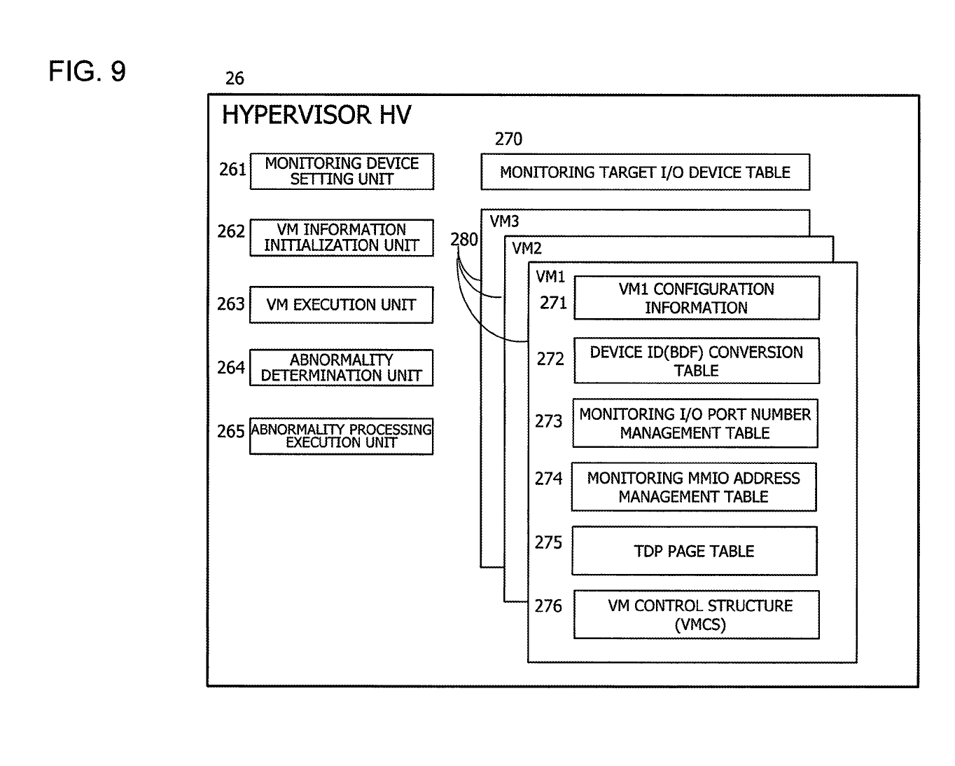

FIG. 9 is a diagram illustrating a configuration example such as program modules and tables of the hypervisor. The hypervisor 26 has a monitoring device setting unit 261. The CPU executes the monitoring device setting unit 261 to register a DPC-incompatible I/O device among I/O devices connected to the I/O bus bridge as a monitoring target I/O device. The monitoring device setting unit 261 is a kind of program module.

The hypervisor 26 has a VM information initialization unit 262 that initializes virtual machine information. The VM information initialization unit 262 is also a kind of program module. When the hypervisor 26 activates a virtual machine the first time, the CPU executes the VM information initialization unit 262 to initialize the information of the respective virtual machines VM1, VM2, and VM3. Examples of the initialized virtual machine information include a device ID conversion table 272, a monitoring I/O port number management table 273, a monitoring MMIO address management table 274, a two dimensional paging (TDP) page table 275, and a VM control structure (VMCS) 276 in an information file 280 of each of the virtual machines VM1, VM2, and VM3 in FIG. 9. Specific examples of these items of information will be described later.

Further, the hypervisor 26 has a VM execution unit 263 that performs control such as activation, operation, temporary stopping (suspension), resumption, or stopping of a virtual machine. The VM execution unit 263 is a kind of program module. The CPU executes the VM execution unit 263 to control the activation, operation, suspension, resumption, and stopping of the virtual machine based on virtual machine configuration information 271. The virtual machine configuration information 271 is a kind of file that is included in the information file 280 of the virtual machine and has the specifications of the virtual machine (the number of CPUs or CPU cores, a CPU clock frequency, a memory size, a disk size, a network bandwidth, and the like).

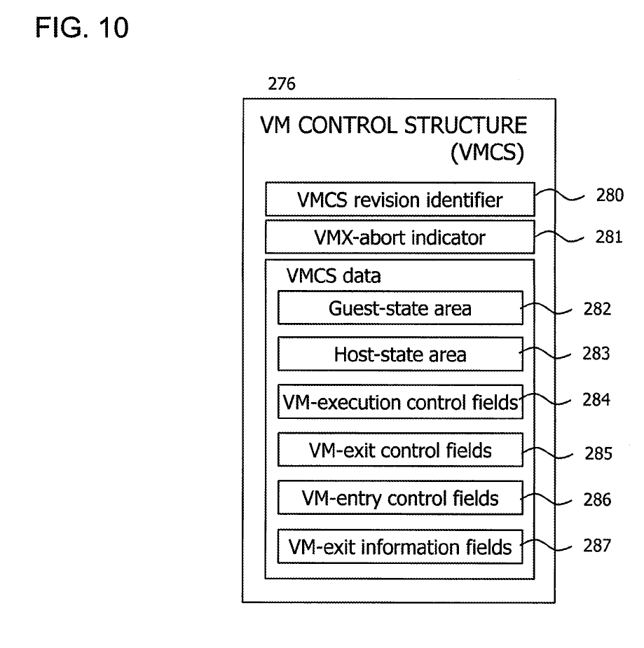

FIG. 10 is a diagram illustrating a configuration example of a VM control structure (VMCS). The VM control structure 276 is a data structure that records the state, the setting, and the like of a virtual machine as described in Section [Related Technologies]. The VM control structure 276 has the following configurations.

A VMCS revision identifier 280 is an area in which version information is written.

A VMX-abort indicator 281 is an area in which an error code is written when an error occurred in the event of VM_Exit and it was unable to write data of the VM_Exit reasons in the VM control structure VMCS.

VMCS data is an area in which various items of data are read and written.

A guest-state area 282 is an area in which registers in the CPU of a guest VM in the event of VM_Exit are saved so that the guest VM returns in the event of VM_Entry.

A host-state area 283 is an area in which registers in the CPU of a hypervisor in the event of VM_Entry are saved so that the hypervisor returns in the event of VM_Exit.

VM-execution control fields 284 are fields in which information on events in which VM_Exit occurs during execution of a guest VM is set. In the second embodiment, when a hypervisor activates a virtual machine VM, the hypervisor set in this field that a VM_Exit occurs upon execution of an I/O instruction. With this initial setting, the CPU executes VM_Exit in response to execution of an I/O instruction. Specifically, the virtual ization-compatible instruction execution unit in the CPU executes VM_Exit upon execution of the I/O instruction. The details thereof will be described later.

VM-exit control fields 285 are areas in which behavior of the CPU in the event of VM_Exit is set.

VM-entry control fields 286 are areas in which behavior of the CPU in the event of VM_Entry is set.

VM-exit information fields 287 are areas in which the reasons or the like of VM_Exit are written when VM_Exit occurs.

As described above, the reasons for VM_Exit in a VM mode during operation of VM are set in the VM-execution control fields 284 of the VM control structure (VMSC) 276, and the reasons for the occurrence of VM_Exit when VM_Exit occurred actually are written in the VM-exit information fields 287 of the VM control structure.

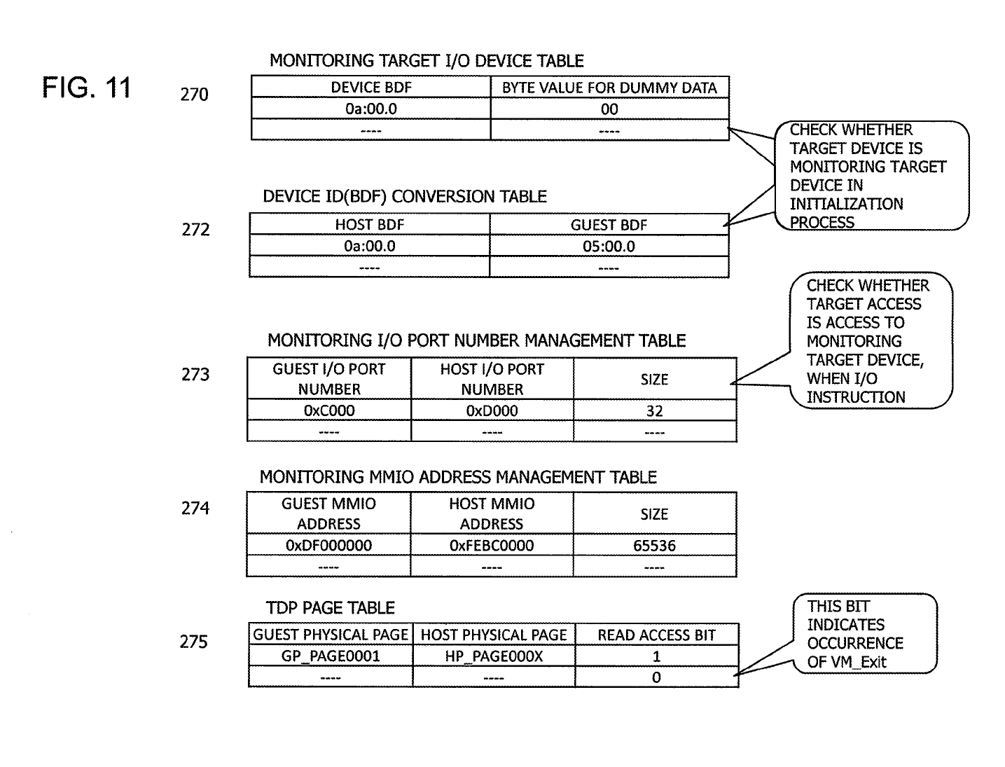

FIG. 11 is a diagram illustrating an example of respective tables in the virtual machine information file 280 of FIG. 9. Hereinafter, the respective tables will be described.

The monitoring target I/O device table 270 (not shown in FIG. 9) is a table in which an I/O device of a DPC-incompatible device driver among the I/O devices connected to the I/O bus bridge is registered. This table is generated for respective virtual machines VMs. In the second embodiment, a user registers an I/O device in the monitoring target I/O device table in advance using the monitoring device setting unit 261 of the hypervisor 26. Examples of a device ID registered therein include a combination of BDFs (bus number, device number, and function number) of an I/O device. The BDF is a set of unique numbers within the information processing device 1.

The device ID conversion table 272 is an ID conversion table of all passthrough target I/O devices connected to the I/O bus bridge. This table is generated for respective virtual machines VMs. The device ID conversion table 272 registers the BDF (a guest BDF) as seen from the guest VM side and the BDF (a host BDF) as seen from the host (the hypervisor) side in correlation. In the second embodiment, a user creates the device ID conversion table 271 in advance using the VM information initialization unit 262 of the hypervisor 26. The meaning of passthrough is described in Section [Related Technologies].

The VM information initialization unit 262 of the hypervisor generates the monitoring I/O port number management table 273 and the monitoring MMIO address management table 274 for a monitoring target device by referring to the monitoring target I/O device table 270 and the device ID conversion table 272 in an initialization process when a virtual machine VM is activated. Moreover, the VM information initialization unit 262 generates the TDP page table 275 for all I/O devices.

The monitoring I/O port number management table 273 is a correlation table of an I/O port number (and size) as seen from the guest VM and an I/O port number (and size) accessible from the host of the I/O device and is generated for a monitoring target I/O device. Since a guest VM uses an I/O port number as seen from the guest VM when accessing an I/O device, the hypervisor checks whether the access is an access to a monitoring target I/O device by referring to the monitoring I/O port number management table 273. Moreover, when the guest VM performs an access to an I/O space of an I/O device, the hypervisor converts the I/O port number of the access to the I/O device by the guest VM to an I/O port number accessible from the host by referring to the monitoring I/O port number management table 273 and emulates the access.

The monitoring MMIO address management table 274 is a correlation table of a MMIO address (and size) as seen from the guest VM and a MMIO address (and size) accessible from the host of the I/O device and is generated for a monitoring target I/O device. Since a guest VM uses a MMIO address as seen from the guest VM when accessing an I/O device, the hypervisor converts the MMIO address of the access to the I/O device by the guest VM to a MMIO address accessible from the host by referring to the monitoring MMIO address management table and emulates the access.

The TDP page table 275 registers correlation between a guest physical page and a host physical page in a MMIO area for all I/O devices. Moreover, “0” indicating the occurrence of VM_Exit is set to a read access bit of the entries of a guest physical page and a host physical page of the monitoring target I/O device in the TDP page table. Due to this, when a read access to a monitoring target I/O device occurs, the CPU refers to the TDP page table 275 and executes VM_Exit according to the read access bit “0” . In this way, VM_exit occurs automatically by the operation of the CPU in the event of a read access to the monitoring target I/O device. Specifically, a virtualization-compatible memory management unit (MMU) (described later) of the CPU executes VM_Exit. This operation is an operation of detecting a read access to a MMIO space of the monitoring target I/O device. The TDP page table corresponds to the extended page table (EPT) of the Intel Corporation.

### Configuration of CPU and BAR

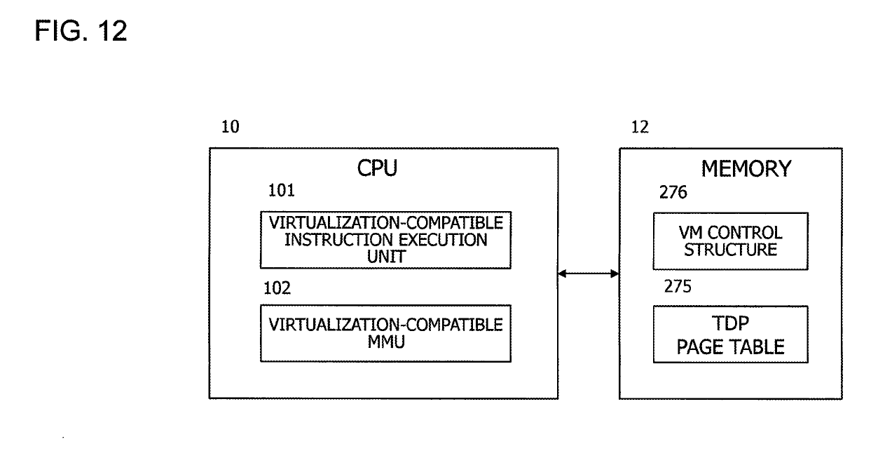

FIG. 12 is a diagram illustrating a hardware configuration corresponding to virtualization of the CPU according to the present embodiment. In order to reduce overheads caused by the virtualization control of the hypervisor, the CPU and the I/O bus bridge have dedicated circuit configurations. As illustrated in FIG. 12, the CPU 10 includes a virtualization-compatible instruction execution unit 101 and a virtualization-compatible memory management unit (MMU) 102. These units are all configured as logical circuits.

Upon detecting that a specific instruction (for example, an I/O instruction) is executed in an execution mode (the VM mode) of a guest VM, the virtual ization-compatible instruction execution unit 101 automatically executes VM_Exit based on the setting of the VM_Exit reasons in the VM control structure (VMCS) 276 (VM-execution control fields 284) in the memory 12 and transitions to a hypervisor execution mode (the HV mode). Thus, as explained before, it is set in the VM control structure 276 of each VM that VM_Exit is executed in response to a specific instruction, and the address of the VM control structure (VMCS) 276 is notified to the CPU 10.

In the second embodiment, when a virtual machine VM executes the I/O instruction, the virtualization-compatible instruction execution unit 101 in the CPU automatically executes VM_Exit and transitions to the HV mode. After that, the VM execution unit 263 of the hypervisor checks whether the access is an access to a monitoring target I/O device by referring to the monitoring I/O port number management table 273. In this way, the hypervisor detects whether the access is an access to the monitoring target I/O device. This operation is an operation of detecting an access to an I/O space of the monitoring target I/O device.

When an access to an I/O device occurs via a MMIO space, the virtualization-compatible MMU 102 converts a guest physical page to a host physical page by referring to the TDP page table 275 and automatically executes VM_Exit when the read access bit is set to “0”. This operation is an operation of detecting an access to a MMIO space of the monitoring target I/O device.

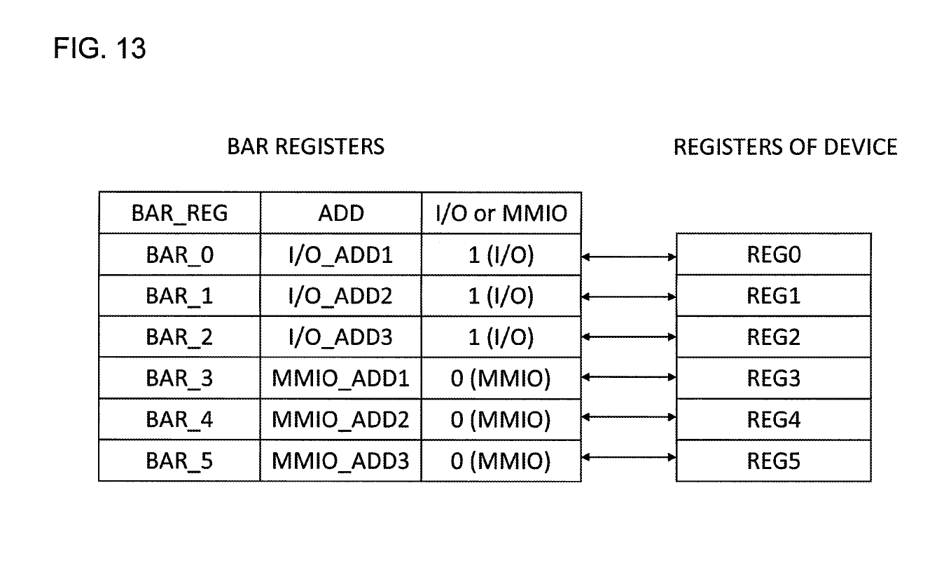

FIG. 13 is a diagram illustrating a configuration example of a BAR register. The I/O device has a BAR register BAR_REG correlated in hardware with a register of the I/O device. During activation of the information processing device, an initialization program makes initial settings by writing, in the BAR registers, the address of an I/O space or a MMIO space allocated to registers corresponding to the BAR registers and the bit “1” or “0” indicating whether the written address is the I/O space or the MMIO space to BAR registers BAR_REG. In this way, when an access request is issued, an I/O device compares the address set in the BAR and the address in the access request to determine an access destination register.

### Overview of Operation of Second Embodiment

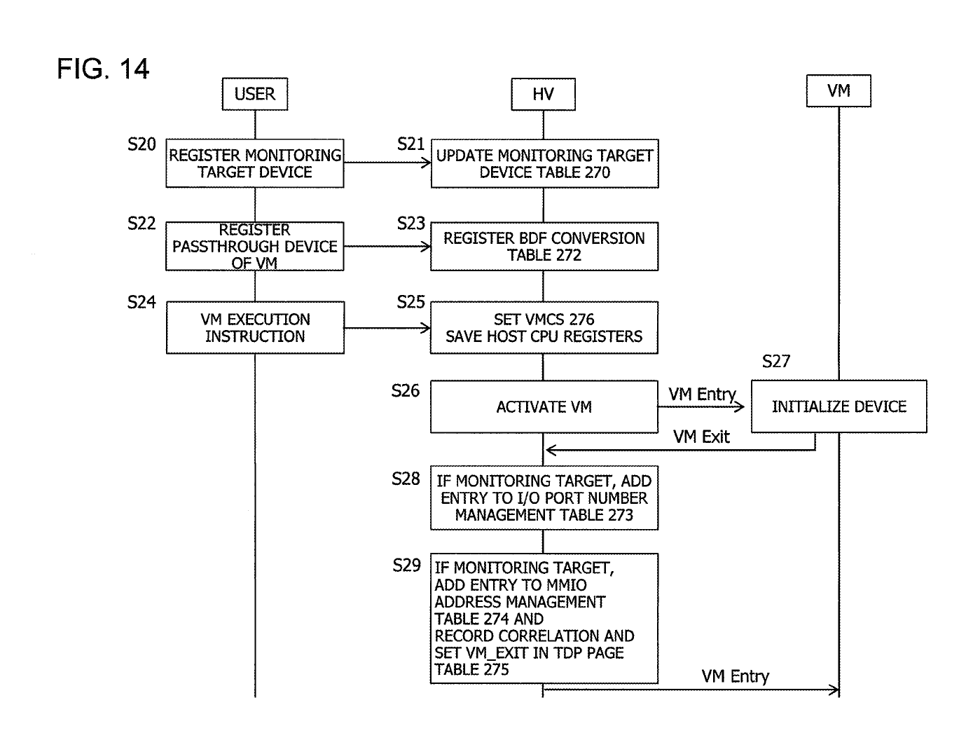

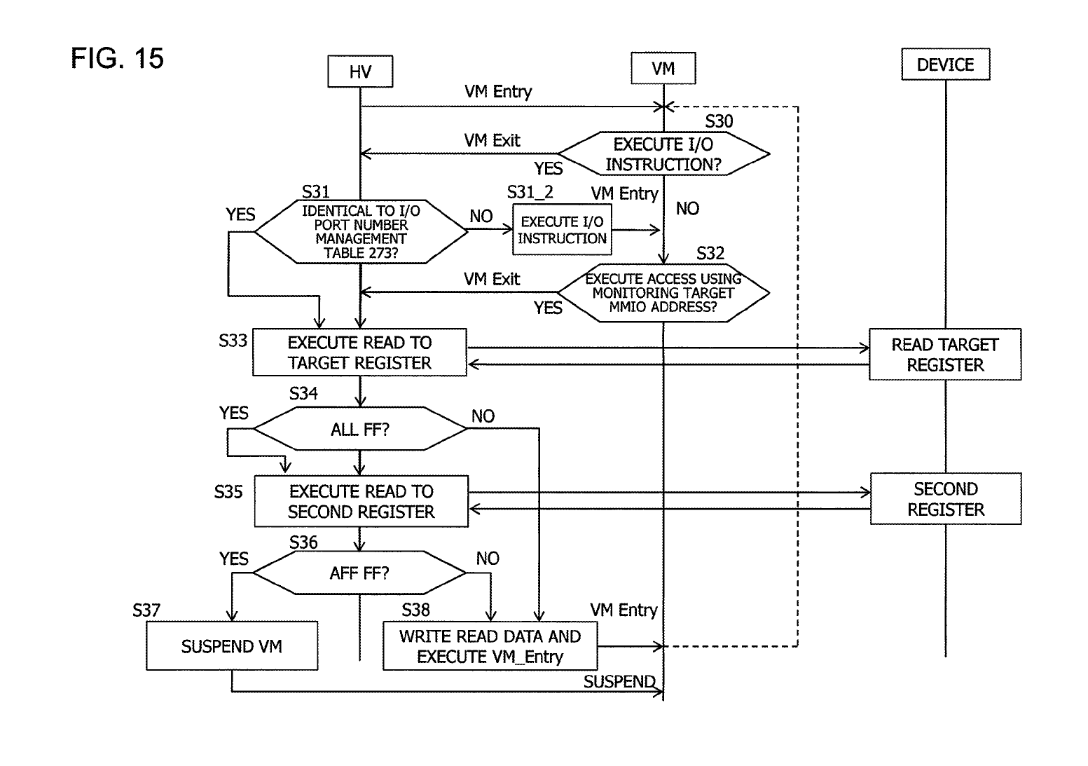

FIGS. 14 and 15 are flowcharts illustrating an outline of the operation of the information processing device according to the second embodiment.

### 1. Overall Initialization, see FIG. 14

In response to an instruction from a user, the monitoring device setting unit 261 of the hypervisor 26 registers a monitoring target I/O device in a monitoring target device table 270 in the hypervisor 26 (S20, S21). The monitoring target I/O device is an I/O device accessed by a DPC-incompatible device driver.

Specifically, a BDF number of the monitoring target I/O device is registered in the table 270 as described in FIG. 11.

Further, in response to the instruction from the user, the VM information initialization unit 262 of the hypervisor registers all I/O devices that are directly accessed in a passthrough manner from the virtual machine VM activated by the hypervisor in the device ID conversion table 272 (S22, S23). See the explanation about “PCI passthrough” is [Related technologies] in later. In this case, a BDF value recognized from the guest VM and the corresponding BDF value on the host side are registered in the device ID conversion table 272.

Further, in response to an instruction to execute (or activate) a virtual machine VM from the user, the VM information initialization unit 262 of the hypervisor makes such setting in the VM control structure (VMCS) 276 of the activation target virtual machine VM that VM_Exit is executed in response to an I/O instruction (S24, S25). In this way, it is set such that the virtualization-compatible instruction execution unit 101 of the CPU 10 executes VM_Exit in response to all I/O instructions. Moreover, in this case, the VM information initialization unit 262 saves the registers for the host in CPU, which are not set as storing targets in the VM control structure (S25).

### 2. Initialization of VM, see FIG. 14

Subsequently, the VM execution unit 263 of the hypervisor activates a virtual machine VM and executes VM_Entry to enter into a VM mode which is the operation mode of the virtual machine VM (S26). Specifically, the VM execution unit 263 registers VM control information in the VM control structure 276, and switches the context (the register value) of the CPU to the value of the guest VM, to activate the virtual machine VM. The activation operation involves executing BIOS of the virtual machine VM, executing a boot loader of the VM, and executing an activation program.

During this activation, the virtual machine VM enters into a VM mode and the VM execution unit 263 of the hypervisor executes an I/O device initialization process (S27). In the I/O device initialization process, the I/O space and the MMIO space of the I/O device that are recognized by the guest VM are set to the BAR in the I/O device as shown in FIG. 13. The initialization flow of setting addresses to the BAR in the I/O device involves an I/O instruction. Thus, the virtualization-compatible instruction execution unit 101 of the CPU detects an I/O instruction of the initialization flow, executes VM_Exit based on the setting of the VM_Exit reasons in the VM-execution control fields 284 of the VM control structure (VMCS) 276, and enters into the HV mode which is the operation mode of the hypervisor.

When the address set to the BAR in the initialization process is the I/O space, and the access destination is the BAR of the monitoring target device, the VM execution unit 263 of the hypervisor registers a set of a guest I/O port number (and size) and a host I/O port number (and size) in the monitoring I/O port number management table 273 (S28).

Specifically, the VM execution unit 263 of the hypervisor extracts a host-side BDF value associated with the guest-side BDF value which is the device ID of the I/O access by referring to the device ID conversion table 272 and determines whether the access is an access to the monitoring target I/O device by referring to the monitoring target device table 270. When the I/O instruction is an I/O instruction to the monitoring target I/O device, the VM execution unit 263 registers the set of I/O port numbers in the monitoring I/O port number management table 273. The information on the I/O port number accessed by the guest VM is acquired from the VM-exit information fields 287 of the VM control structure (VMCS) 276.

When the address set to the BAR in the initialization process is a MMIO address and the access destination is the monitoring target device, the VM execution unit 263 of the hypervisor registers a set of a guest MMIO address and a host MMIO address in the monitoring MMIO address management table 274. Further, the VM execution unit 263 registers a set of a guest physical page and a host physical page in the MMIO area in the TDP page table 275. In this case, it is set such that VM_Exit is to be executed (read access bit is set to “0”) (S29). The determination as to whether the access destination is the monitoring target device is the same as that in the I/O space.

In this way, the VM initialization flow ends, and the VM execution unit 263 executes VM_Entry, returns to the VM mode which is the operation mode of the virtual machine VM, and proceeds to a normal operation of the virtual machine VM.

### 3. Normal Operation after VM Initialization, see FIG. 15

In the normal operation of the VM mode, the virtual machine VM accesses to the I/O device with an I/O instruction (I/O space) or a read access to MMIO space. Therefore, an I/O instruction or a read access to the monitoring target I/O device is detected by the initially set tables, and the hypervisor executes a read access to the first register in the monitoring target I/O device to check if the I/O device is abnormal state or not.

When a virtual machine VM executes an I/O instruction, the virtualization-compatible instruction execution unit 101 of the CPU automatically executes VM_Exit based on the setting of the VM control structure (VMCS) 276 (S30: YES). Alternatively, when the virtual machine VM executes an access (a read access) to a MMIO address of the monitoring target I/O device, the virtualization-compatible MMU 102 of the CPU automatically executes VM_Exit based on the read access bit “0”0 corresponding to the MMIO address of the monitoring target I/O device when converting the guest physical page to the host physical page by referring to the TDP page table 275 (S32: YES). With these VM_Exits, the operation mode transitions to the HV mode.

When VM_Exit is executed in response to the I/O instruction, all non-monitoring target devices execute VM_Exit in response to the I/O instruction. Thus, in the HV mode, the VM execution unit 263 acquires the I/O port number of the access destination and the reasons (I/O instruction) of VM_Exit from the VM-exit information field in the VM control structure (VMCS) 276 and determines whether the access is an access to the monitoring target I/O device by referring to the monitoring I/O port number management table 273 (S31). If the access destination I/O port number is identical to the guest I/O port number in the monitoring I/O port number management table 273, it is proved that the access is an access to the monitoring target I/O device. That is, the I/O port number in the monitoring I/O port number management table is one of the first addresses which are the access addresses to the monitoring target I/O device.

If the access destination I/O port number is not identical to the guest I/O port number in the monitoring I/O port number management table 273, the VM execution unit 263 emulates the I/O instruction on behalf or the VM (S31_2).

On the other hand, when VM_Exit occurs in response to the read access to the MMIO space of the monitoring target I/O device (S32: YES), it has been proved already that the access is a read access to the monitoring target I/O device. That is, the address in the monitoring MMIO address management table 274 is one of the first addresses which are the access addresses to the monitoring target I/O device.

Subsequently, the VM execution unit 263 emulates the read access to the I/O device that the virtual machine VM tried to execute (S33). Thus, the VM execution unit 263 acquires a host-side I/O port number by referring to the monitoring I/O port number management table 273. Alternatively, the VM execution unit 263 acquires a host-side MMIO address by referring to the monitoring MMIO address management table 274. Moreover, the VM execution unit 263 reads the value of the register (a first register) of the I/O device, that the virtual machine VM tries to read, using the host-side I/O port number or the host-side MMIO address (S33).

Subsequently, an abnormality determination unit 264 of the hypervisor determines whether the access destination I/O device is disconnected from the I/O bus bridge and is in an abnormal state. First, it is determined whether the data value of the read access to the I/O device is ALL “F” (S34). ALL “F” is a value sent as a response when the I/O device is in an abnormal state.

If the read data is ALL “F” (S34: YES), the abnormality determination unit 264 reads another register (a second register in a second address area, which always contains a “0”-bit) of the I/O device to check whether the ALL “F” in S34 is a normal value or an abnormal value (S35). Moreover, it is determined whether the read value is also ALL “F” (S36).

If the read data of the other register is ALL “F” (S36: YES), the access destination I/O device is certainly in the abnormal state. Thus, an abnormality processing execution unit 265 of the hypervisor stops (forcibly shuts down) the virtual machine VM (S37). In this way, the read data from the first register is not sent to the virtual machine VM as a response so that the read access to the first register is suspended.

On the other hand, if the read data of the other register is not ALL “F” (S36: NO), it is determined that the access destination I/O device is in the normal state and the previous read value of ALL “F” is a normal value. Moreover, the VM execution unit 263 stores the value read from the first register of the first address area in the register or the memory of the virtual machine VM. In this way, the operation of the read access to the I/O device ends. Moreover, the VM execution unit 263 executes VM_Entry and proceeds to a VM mode (S38).

When the read data obtained by reading the access destination register of the I/O device in S33 is not ALL “F” (S34: NO), the abnormality determination unit 264 detects that the I/O device is in a normal state, writes the read data obtained in the read emulation S33 to the memory of the corresponding virtual machine VM or the register in the CPU, and executes VM_Entry (S38).

### Another Example of Abnormality Processing of Abnormality Processing Execution Unit

In the above description, when it is proved that the access destination I/O device is in the abnormal state, the abnormality processing execution unit 265 stops the virtual machine VM that executed the I/O access.

However, depending on the specifications of a monitoring target I/O device, when safe dummy data for responding to a virtual machine VM upon detection of an abnormal value is present, the abnormality processing execution unit 265 stores the dummy data in the register or the memory of the virtual machine VM instead of the abnormal value and executes VM_Entry. Safe dummy data does not cause an inappropriate memory access or the like. In this case, read emulation to the I/O access destination is suspended and the I/O access is suppressed.

In order to use safe dummy data as read data instead of an abnormal value, it is desirable to set safe dummy data to the monitoring target I/O device table 270. Such dummy data (BYTE VALUE FOR DUMMY DATA) is illustrated in the monitoring target I/O device table 270 of FIG. 11.

As described above, in the second embodiment, when a virtual machine executes a read access to a monitoring target I/O device, such read access is detected and the VM execution unit 263 of the hypervisor performs an operation of reading the I/O device and emulates a read access to the I/O device. When the read data obtained by the read access is the same as the abnormal value ALL “F,” the VM execution unit 263 of the hypervisor reads the second register of the second address to check whether the read data is a normal value or an abnormal value. If the read data is the same as the abnormal value ALL “F,” the abnormality determination unit 264 determines that the I/O device is in an abnormal state. When it is determined that the I/O device is in the abnormal state, the VM execution unit 263 forcibly shuts down the virtual machine. Thus, the emulated read data is not stored in the register or the memory of the virtual machine and the read access to the I/O device is suspended (or suppressed).

In the second embodiment, the second register (a register that always contains a “0”-bit) is read after the I/O read access is emulated, and it is checked whether the I/O device is in an abnormal state. Thus, when the read data of the second register is not an abnormal value, the emulated read data is stored in the register or the memory of the virtual machine (S38).

Thus, the second embodiment is different from an operation in which the device driver executes a read access after the read check device driver checks the data of the second register as in the first embodiment.

In the second embodiment, in order to detect an access to a monitoring target I/O device by a virtual machine VM, the functions of the virtualization-compatible instruction execution unit 101 and the virtualization-compatible MMU 102 of the CPU are used. That is, a read access to an I/O device comes in two types: one is an I/O port access performed by designating an I/O port number using an I/O instruction and the other is a read access performed by designating a MMIO address using a read instruction.

In the case of an access to an I/O space, the virtualization-compatible instruction execution unit 101 of the CPU executes VM_Exit upon detecting an I/O instruction, and the VM execution unit 263 checks whether the I/O port number is identical to the I/O port number of the monitoring target I/O device in the HV mode to detect an access to the monitoring target I/O device.

In the case of an access to a MMIO space, the virtualization-compatible MMU 102 of the CPU executes VM-Exit based on READ ACCESS BIT=“0” of the TDP page table 275. Thus, an automatic detection mechanism of the hardware circuits 101 and 102 of the CPU detects an access to the monitoring target I/O device. However, in the case of an access to the I/O space, the VM execution unit 263 of the hypervisor finally detects the access.

In the second embodiment, in response to an I/O instruction for setting the BAR in an initialization step S27 of an I/O device when a virtual machine VM is activated, the CPU automatically executes VM_Exit based on the I/O instruction and enters into a hypervisor mode. This is because it is set as the VM_Exit reasons in the VM control structure (VMCS) 276. Moreover, in the HV mode, the VM execution unit 263 creates correlation tables (management tables 273, 274) that has an I/O port number and a MMIO address of the guest VM and the host for the monitoring target I/O device, and makes setting of VM_Exit in the TDP page table 275. The monitoring I/O port number management table 273 is used for checking whether an access is an I/O port access to the monitoring target I/O device. The TDP page table 275 is used for checking whether VM executes VM_Exit when MMIO read access. Further, the monitoring I/O port number management table and the monitoring MMIO address management table are referenced in a read or write emulation process by the VM execution unit 263 of the hypervisor.

### Specific Operation Example of Second Embodiment

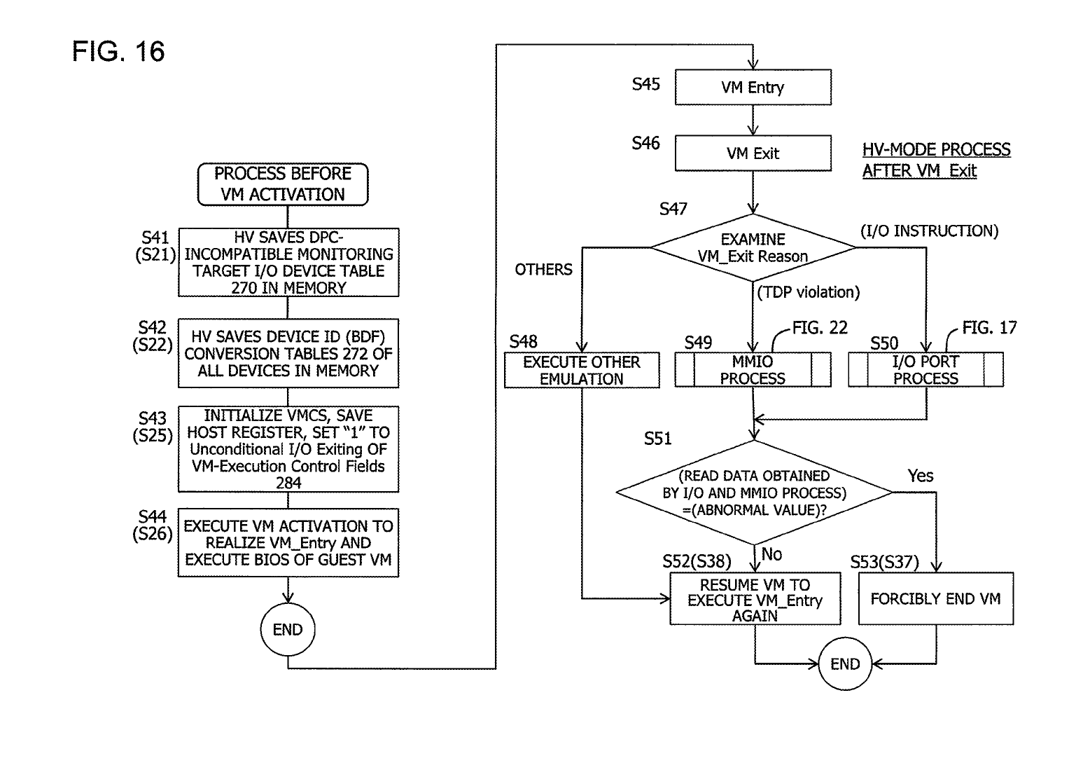

Hereinafter, a specific operation example of the second embodiment will be described. FIGS. 16 to 22 are flowcharts illustrating a specific operation example of the second embodiment. These flowcharts include processes after VM_Exit occurs due to two VM_Exit reasons. A first VM_Exit reason is VM_Exit that occurs in response to an I/O instruction in initialization of an I/O device during activation of VM. A second VM_Exit reason is VM_Exit that occurs in response to an access (an I/O instruction and a read or write instruction to a MMIO address) to a monitoring target I/O device in the VM mode. Thus, these flowcharts include an initialization process (a write operation) in the HV mode after the first VM_Exit and a read emulation operation in the HV mode after the second VM_Exit. The same steps as the steps in FIGS. 14 and 15 are denoted by the same steps numbers as those in FIGS. 14 and 15.

FIG. 16 is a flowchart illustrating an outline of a process before activation of the virtual machine VM and the process when VM_Exit occurs after VM_Entry of the activation occurred. In the process before activation of VM, the hypervisor HV creates a DPC-incompatible I/O device table (the monitoring target I/O device table 270) and stores the table in the memory (S41 (S21)). Further, the hypervisor HV creates a device ID (BDF) conversion table 272 of all passthrough-compatible I/O devices in the memory (S42 (S22)). Moreover, the hypervisor HV initializes the VM control structure (VMCS) 276 and sets “1” to the unconditional I/O exiting bit in the VM-execution control fields 284 (S43 (S25)). With this setting, all I/O instructions cause VM_Exit.

Subsequently, the VM execution unit 263 of the hypervisor HV activates a virtual machine VM to execute VM_Entry (S44 (S26)). In activation of a virtual machine VM, the CPU executes a BIOS of the virtual machine to activate the virtual machine VM (S44 (S26)). In the VM_Entry state after activation, the VM execution unit 263 executes VM_Exit for various reasons (S45,

S46). The reasons for the VM_Exit include execution of an I/O instruction and a TDP page fault (TDP violation) resulting from a read access to a MMIO address of a monitoring target I/O device.

When VM_Exit is executed and a HV mode starts, the VM execution unit 263 of the hypervisor examines the reasons for the VM_Exit by referring to the VM control structure (VMCS) 276 and executes an I/O port process S50 if the I/O instruction is the reason, or a MMIO process S49 if the reason is a TDP page fault, and the other emulation process S48 if the reason is the other reason. As described above, the I/O port process S50 is a process performed after VM_Exit occurs in response to an I/O instruction in initialization of an I/O device during activation of VM and an I/O instruction during the normal operation. On the other hand, the MMIO process S49 is a process performed after VM_Exit occurs in response to an access to the monitoring target I/O device during the normal operation. The I/O port process S50 and the MMIO process S49 will be described in detail later.

When it is detected that the read data of the second register, obtained by the I/O port process S50 and the MMIO process S49 is an abnormal value (S51: YES), the virtual machine VM is forcibly stopped (S53 (S37)). When the read data is not an abnormal value (S51: NO) or the other emulation process is executed (S48), the VM execution unit 263 resumes the virtual machine VM and executes VM_Entry again (S52 (S38)).

The I/O port process S50 and the MMIO process S49 will be described below. The I/O port process S50 includes a write process during initialization of an I/O device, a read and write emulation process when accessing an I/O device during the normal operation, and other processes. Moreover, the MMIO process S49 includes a read and write emulation process when accessing an I/O device during the normal operation, and other processes. Moreover, the read emulation process during the normal operation includes a process of determining whether the I/O device is normal or abnormal.

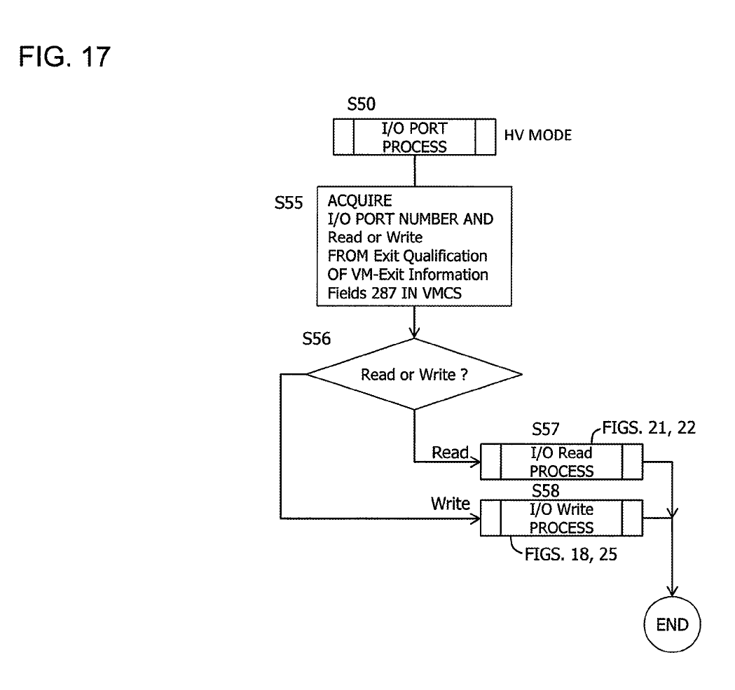

### I/O Port Process, see FIGS. 17 to 21

FIG. 17 is a flowchart of the I/O port process S50 in the HV mode. The VM execution unit 263 acquires an I/O port number and information on a read or a write from the Exit qualification bits (Exit reasons) of the VM-exit information fields of the VM control structure (VMCS) 276. When the exit reason is a read (S56: Read), the VM execution unit 263 executes an I/O read process S57. When the exit reason is a write (S56: Write), the VM execution unit 263 executes an I/O write process S58. The I/O read process S57 does not occur in the initialization process but includes a read emulation in the HV mode after VM_Exit is executed in response to an I/O instruction in the VM mode and a read operation after an abnormal state is checked. The I/O write process S58 includes a write process in the initialization process and write emulation in a non-initialization process.

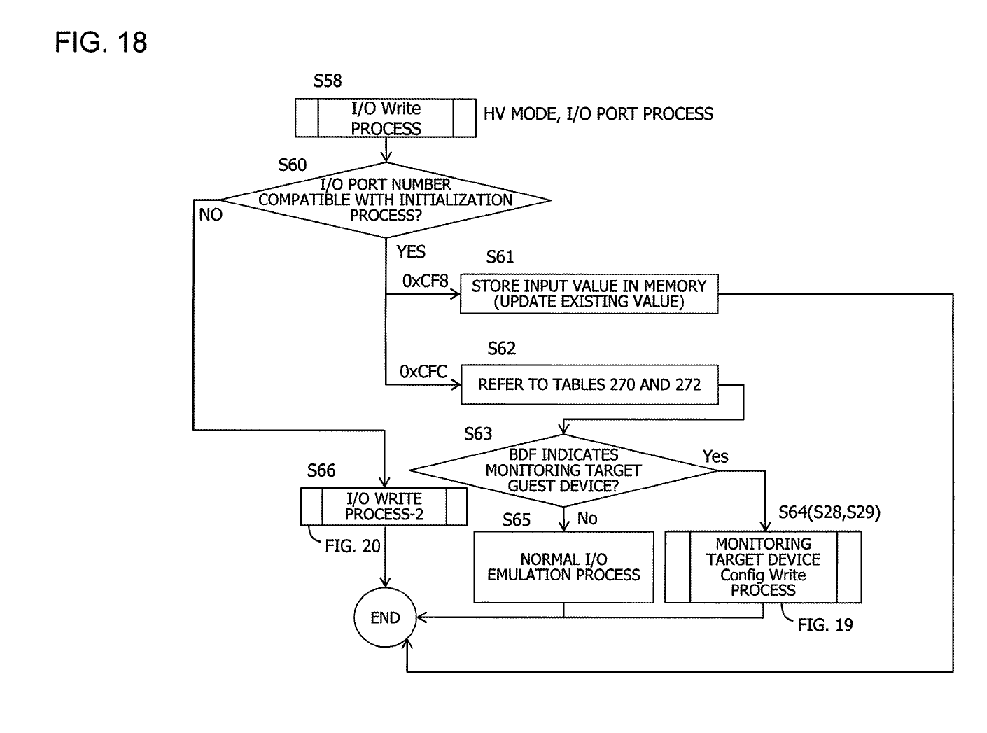

FIG. 18 is a flowchart of the I/O write process S58 included in the I/O port process S50 in the HV mode. When the I/O port number of the I/O write access corresponds to the initialization process of the I/O device (S60: YES), the VM execution unit 263 stores a write input value in the memory (S61). Moreover, the VM execution unit 263 refers to the tables 270 and 272 (S62), and when the host BDF in the table 272 is identical to the device BDF in the monitoring target I/O device table 270 (S63: YES), the VM execution unit 263 performs a write process on a configuration space of the monitoring target I/O device (S64). This process S64 includes the processes S28 and S29 in FIG. 14. When the host BDF is not identical to the device BDF in the monitoring target I/O device table, the VM execution unit 263 performs a normal I/O emulation process.

On the other hand, when the I/O port number of the I/O write access does not correspond to the initialization process of the I/O device (S60: NO), the VM execution unit 263 performs an I/O write process in the normal operation, which is a non-initialization process (S66).

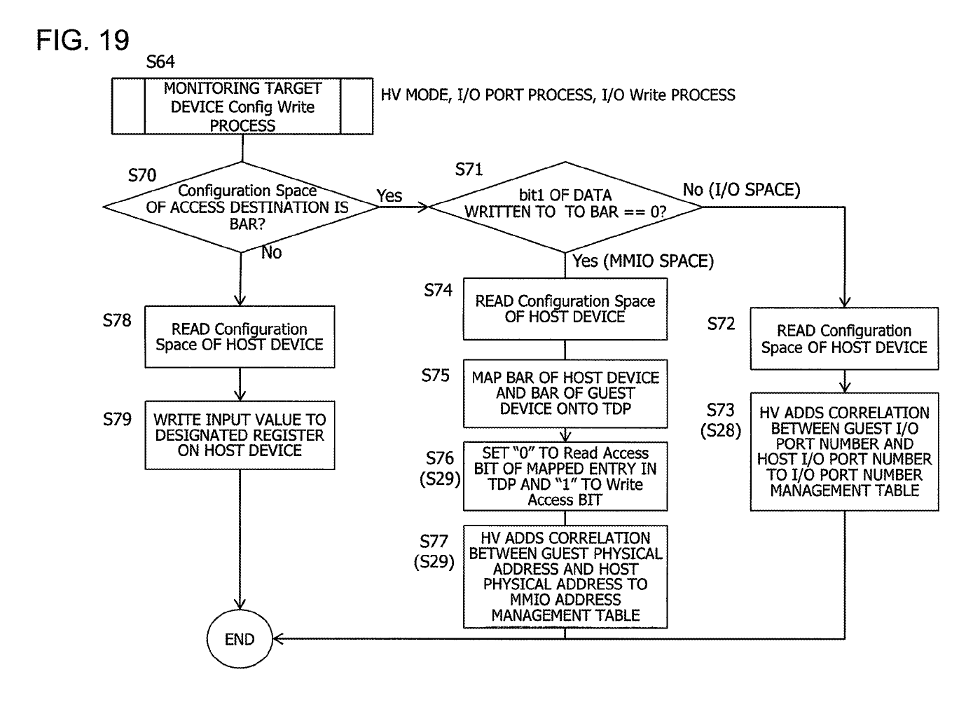

FIG. 19 is a flowchart of the write process S64 on the configuration area of the monitoring target I/O device. When the configuration area of the I/O write access destination is BAR (S70: YES), the VM execution unit 263 determines whether the first bit (bitl) of the data written to the BAR is “0” (S71). When the first bit (bit1) is “0” (MMIO space) (S71: YES), the VM execution unit 263 reads the configuration area of the host I/O device (S74), maps the BAR of the host I/O device and the BAR of the guest I/O device onto the TDP page table 275 (S75), and sets “0” to the read access bit of the mapped entry in the TDP page table and “1” to the write access bit, respectively (S76 (S29)). Further, the VM execution unit 263 adds a correlation between the guest physical page (address) and the host physical page (address) in the MMIO address management table 274 (S77 (S29)). In this way, setting to the TDP page table and registration in the monitoring MMIO address management table in the initialization process are performed.

On the other hand, when bit1 is “1” (I/O space) (S71: NO), the VM execution unit 263 reads the configuration area of the host I/O device (S72) and adds a correlation between the guest I/O port number and the host I/O port number in the I/O port number management table 273 (S73 (S28)). In this way, registration in the monitoring I/O port number management table in the initialization process is performed.

When the configuration area of the I/O write access destination is not BAR (S70: NO), the VM execution unit 263 reads the configuration area of the host I/O device (S78) and writes a write input value to a designated register on the host I/O device (S79). This is a write process for initialization for registers other than BAR.

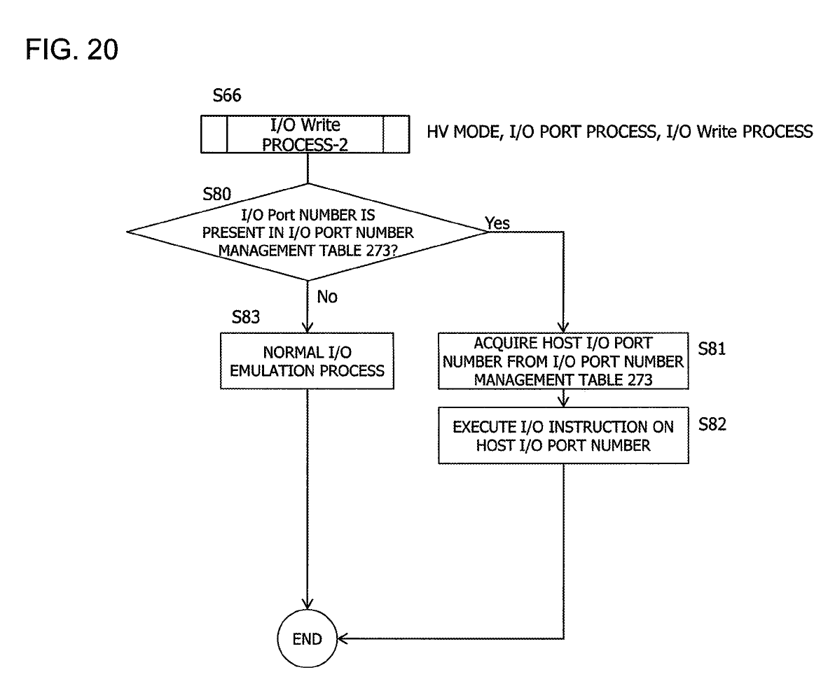

FIG. 20 is a flowchart of the I/O write process S66 in the non-initialization process in FIG. 18. That is, the I/O write process S66 in FIG. 20 is an I/O write emulation process by the VM execution unit 263 in the HV mode after an I/O write access occurs in a normal process in the VM mode and VM_Exit is executed.

When the I/O port number of the I/O write access is present in the monitoring I/O port number management table 273 (S80: YES), since the I/O write access is a write instruction addressed to a monitoring target I/O device, the VM execution unit 263 acquires a host I/O port number from the I/O port number management table (S81). Moreover, the VM execution unit 263 executes an I/O write instruction on the host I/O port number (S82). In the I/O write instruction, read data of ALL “F” will not be responded even when the monitoring target I/O device is in a non-connected state.

On the other hand, when the I/O port number of the I/O write access is not present in the monitoring I/O port number management table (S80: NO), the VM execution unit 263 executes a normal I/O write emulation process (S83).

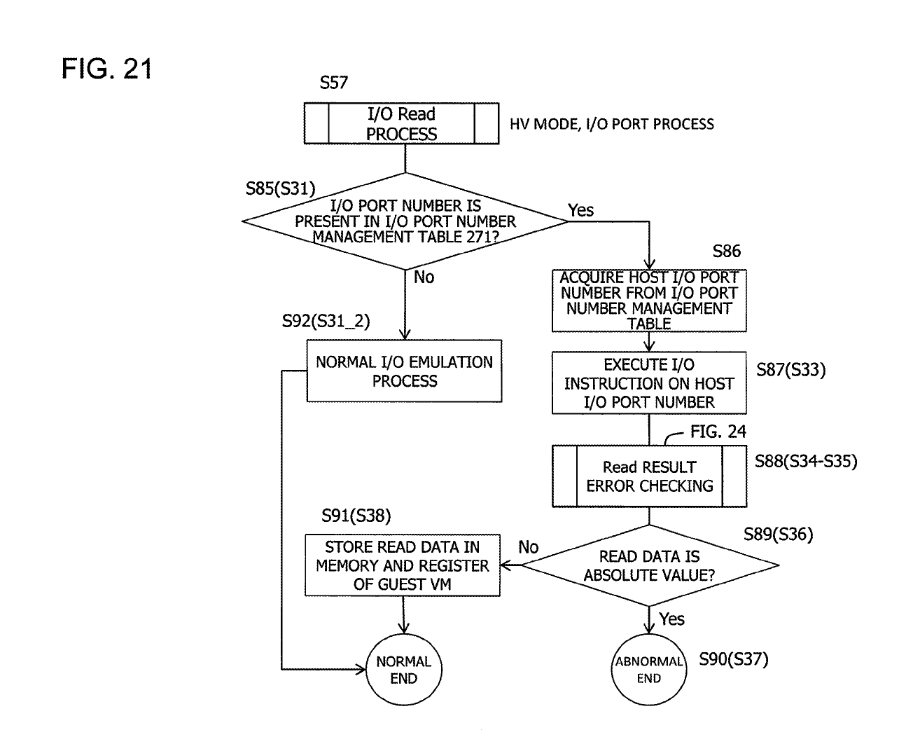

FIG. 21 is a flowchart of the I/O read process S57 in FIG. 17. That is, the I/O read process S57 in FIG. 21 is an I/O read emulation process by the VM execution unit 263 in the HV mode after an I/O read access occurs in a normal process in the VM mode and VM_Exit is executed.

When the I/O port number of the I/O read access is present in the monitoring I/O port number management table 273 (S85: YES), since the I/O read access is a read instruction addressed to the monitoring target I/O device, the VM execution unit 263 acquires a host I/O port number from the I/O port number management table (S86). Moreover, the VM execution unit 263 executes an I/O read instruction on the host I/O port number (S87 (S33)). Further, the VM execution unit 263 checks whether the monitoring target I/O device is in an abnormal state in the non-connected state based on the read data (S88 (S34 to S35)). This error checking process S88 will be described later.

When the read data is an abnormal value (ALL “F”) (S89 (S36): YES), the abnormality processing execution unit 265 shuts down the virtual machine VM (S90 (S37)). On the other hand, when the read data is not the abnormal value (S89 (S36): YES), the VM execution unit 263 stores the read data in the memory and the register (in the CPU) of the guest VM (S91 (S38)). In this way, the I/O read emulation process ends.

On the other hand, when the I/O port number of the I/O read access is not present in the monitoring I/O port number management table (S85 (S31): NO), the VM execution unit 263 executes a normal I/O read emulation process (S91 (S38)).

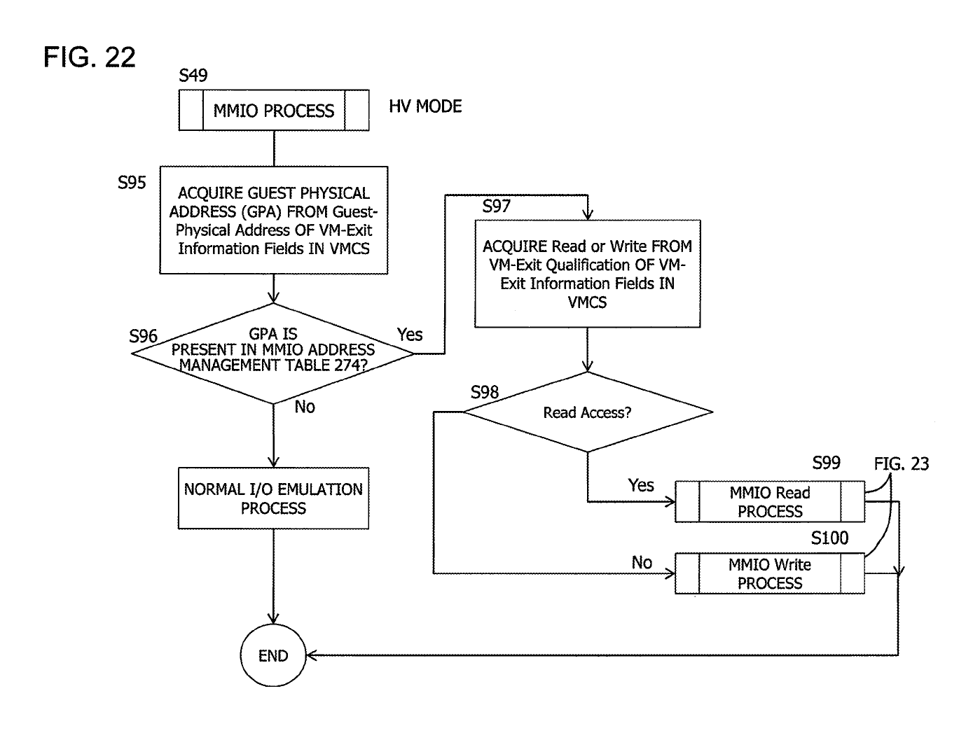

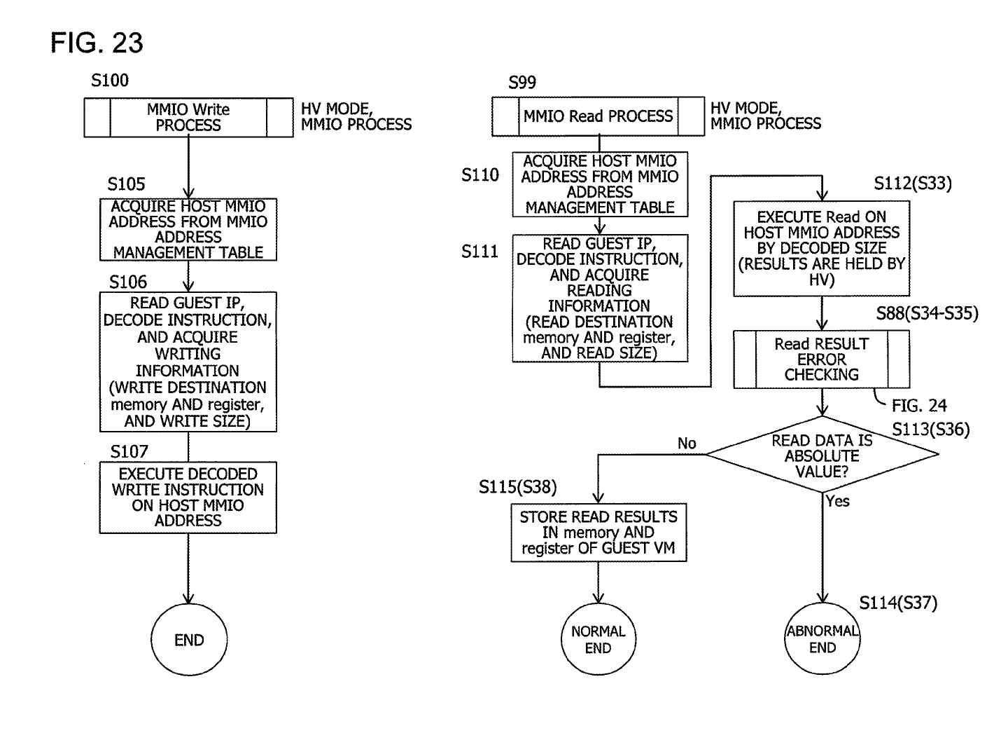

### MMIO Process, see FIGS. 22 and 23

Next, the MMIO process S49 in FIG. 16 will be described. As described in FIG. 16, the MMIO process S49 is a process in the HV mode after the CPU generates a page fault by referring to the TDP page table and VM_Exit is executed. This page fault includes a page fault when a guest VM accesses a MMIO space of a monitoring target I/O device in the VM mode and the other ordinary page faults.

FIG. 22 is a flowchart of the MMIO process S49 in the HV mode. The VM execution unit 263 acquires a guest physical address from guest-physical addresses of the VM-exit information fields in the VM control structure (VMCS) 276 (S95). The guest physical address may be a guest physical address that the virtual machine VM accessed using the MMIO address of the monitoring target I/O device. The VM execution unit 263 checks whether the guest physical address is present in the monitoring MMIO address management table 274. When the guest physical address is present (S96: YES), since this access is an access to the monitoring target I/O device based on the MMIO address, the VM execution unit 263 executes either a MMIO read process S99 or a MMIO write process S100. In order to determine whether the access is a read access or a write access, the VM execution unit 263 acquires a read or a write from the VM-exit qualification bits of the VM-exit information fields in the VM control structure (VMCS) 276 (S97) and makes determination (S98).

On the other hand, when the guest physical address is not present in the monitoring MMIO address management table 274 (S96: NO), since it means that VM_Exit occurred due to an ordinary page fault, the VM execution unit 263 executes a normal I/O emulation process (S101).

FIG. 23 is a flowchart of the MMIO write process S100 and the MMIO read process S99 included in the MMIO process S49 in the HV mode. In the MMIO write process S100, the VM execution unit 263 converts the guest MMIO address of the access to the MMIO address to a host MMIO address by referring to the monitoring MMIO address management table 274 (S105). Further, the VM execution unit 263 reads the value of an instruction pointer (IP) of the guest VM, decodes the instruction of the instruction pointer, acquires writing information (write destination memory and register and a write size) (S106), and executes the decoded write instruction on the host MMIO address (S107).

In the MMIO read process S99, the VM execution unit 263 converts the guest MMIO address of the access to the MMIO address to a host MMIO address by referring to the monitoring MMIO address management table 274 (S110). Further, the VM execution unit 263 reads the value of an instruction pointer (IP) of the guest VM, decodes the instruction of the instruction pointer, acquires reading information (a read destination memory, a register, and a read size) (S111), and executes the decoded read instruction on the host MMIO address (S112 (S33)). The VM execution unit 263 holds the read data.

The VM execution unit 263 checks whether the read data is an abnormal value (S88 (S34 to S35) and shuts down the virtual machine VM (S114 (S37)) when the read data is an abnormal value (S113 (S36): YES). Moreover, when the read data is not an abnormal value (S113 (S36): NO), the VM execution unit 263 stores the read data in the memory and the register of the guest VM (S115 (S38)).

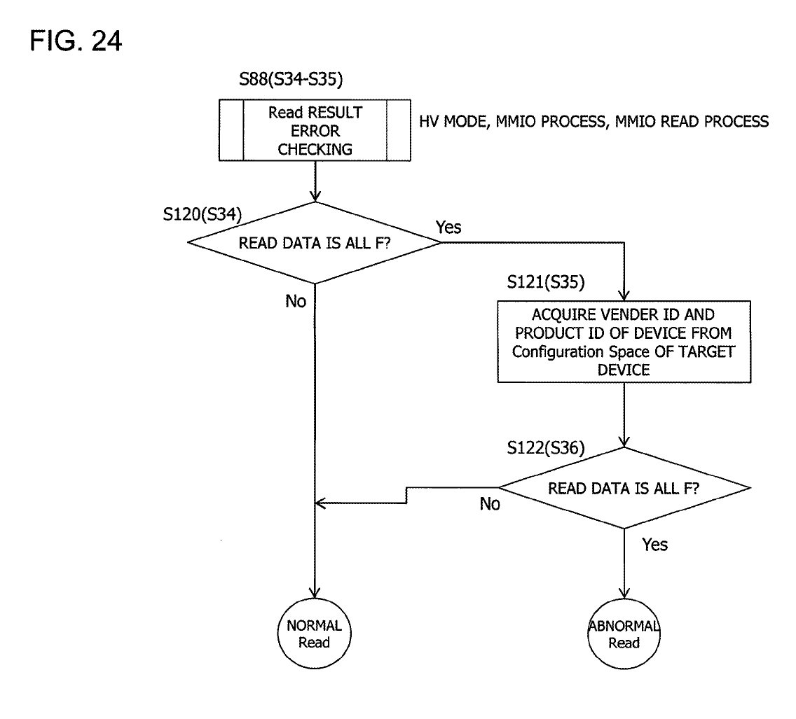

FIG. 24 is a flowchart of the read result error checking process S88 in FIGS. 21 and 23. Similarly to FIG. 15, in FIG. 24, the abnormality determination unit 264 of the hypervisor checks whether the read data is ALL “F” (S120 (S34)). If the read data is not ALL “F” (S120: NO), it is determined that the access destination I/O device is normal. On the other hand, if the read data is ALL “F,” it is needed to check whether the read data of the register data is ALL “F” in the normal state or the read data is ALL “F” in the abnormal state.

Thus, the abnormality determination unit 264 of the hypervisor executes a read emulation on the second register in which the vender ID or the product ID of the I/O device is stored from the configuration area of the access target I/O device (S121 (S35)) and checks whether the read data is ALL “F” (S122 (S36)). When the read data is ALL “F” (S122: YES), the abnormality determination unit 264 determines that the target I/O device is in an abnormal state. On the other hand, when the read data is not ALL “F” (S122: NO), the abnormality determination unit 264 determines that the target I/O device is in a normal state.

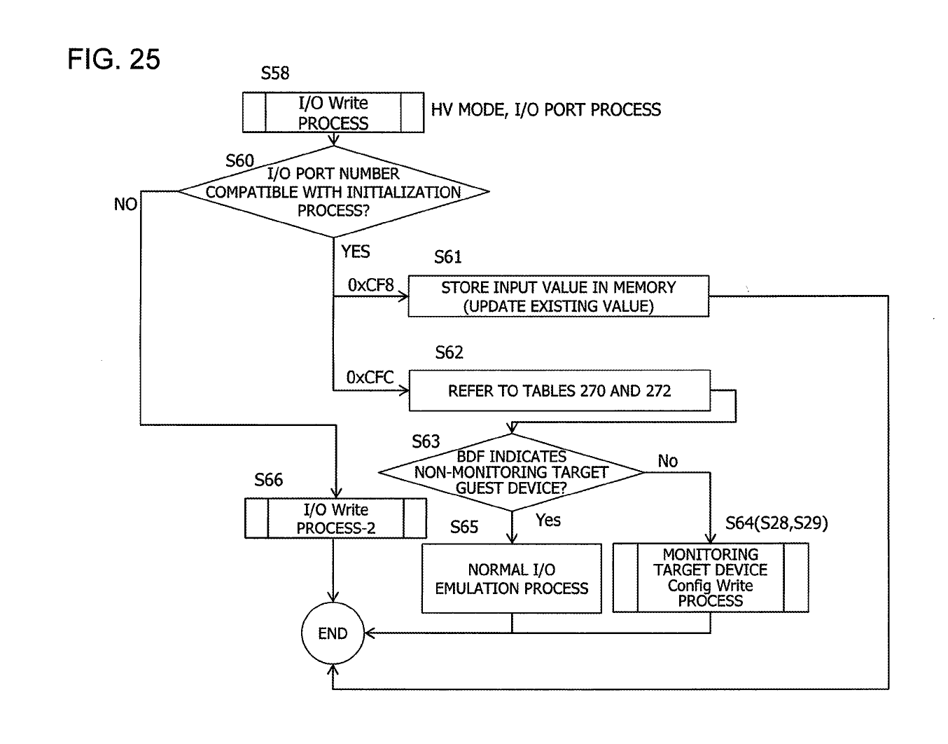

FIG. 25 is a flowchart of a modification of the I/O write process in FIG. 18. In this modification, a non-monitoring target I/O device table is used instead of the monitoring target I/O device table 270. That is, a white list is used instead of a black list. Thus, in FIG. 25, the determination results YES and NO on whether the ID (the BDF value) of the access destination I/O device of the I/O write access indicates a non-monitoring target I/O device (S63) are reverse to those of FIG. 18. That is, when the BDF value indicates a non-monitoring target I/O device (S63: YES), the VM execution unit 263 executes a normal I/O emulation process (S65). When the BDF value does not indicate a non-monitoring target I/O device (S63: NO), the VM execution unit 263 executes a process on the configuration area of the monitoring target I/O device.

As described above, in the second embodiment, when a virtual machine VM accesses an I/O device, it is possible to suppress a device driver of a DPC-incompatible I/O device from performing an inappropriate operation based on the read data acquired in an abnormal state.

### Related Technologies

Hereinafter, the related technologies of the present embodiment will be described briefly. This section is referenced as needed.

### (1) Virtualization Supporting Technologies

In order to reduce overheads caused by virtualization, logical circuits such as a virtualization-compatible instruction execution unit and a virtualization-compatible memory control unit are provided in hardware such as a CPU. In the second embodiment, VM_Exit is executed in a VM mode during an access to a monitoring target I/O device based on the function of the above hardware circuits for supporting the virtualization.

The virtual machine (VM) control structure (VMCS) is a data structure that records the state, the setting, and the like of a virtual machine and is used for exchange of data between a VM mode and a HV mode.

Two dimensional paging (TDP) is a conversion table that enables hardware-based conversion between a guest physical address and a host physical address. A guest OS of a guest VM acquires a guest physical address from a guest virtual address by referring to the TDP page table. The TDP page table is a conversion table for converting a guest physical address to a host physical address.

### (2) Related Technologies of I/O device (Particularly, PCIe Device)

A bus/device/function (BDF) number is a number unique to an I/O device, and an access to an I/O device uses the BDF number that uniquely identifies the I/O device.

For example, a bus configuration space of a PCIe bus or the like is an address space for acquiring basic information on an I/O device and includes the following: For example, BDF and register numbers of a device are written to an I/O port CF8h (a configuration index), and read/write is executed on an I/O port CFCh (configuration data) whereby an access to a configuration space is realized. Product identification information such as a vendor ID or a product ID of an I/O device is acquired from the configuration space, and information on a base address register (BAR) is also acquired therefrom.

The base address register (BAR) is a register in an I/O device, in which an address space for accessing a register group in the I/O device is recorded, and at most six BARs are present in each I/O device, for example. When a virtual machine is activated, a BIOS of a host sets appropriate addresses to the BAR register of each I/O device. The address space of an I/O device has two types of space, an I/O space and a memory mapped I/O (MMIO) space and either one of the address spaces is set to the BAR.

The I/O space is an address space accessed via an I/O port in response to an INPUT instruction and an OUTPUT instruction (I/O instructions), and the address range is between 0x0000 and 0xFFFF, for example.

The memory mapped I/O (MMIO) space is an address space in which a register of an I/O device is directly mapped onto a memory space of a host, and the register in the I/O device is directly accessed in response to a normal memory transfer instruction, i.g. read instruction, using the address of the MMIO space.

PCI passthrough is a function with which a guest VM can directly access an I/O device. According to the PCI passthrough function, a guest operating system can directly and physically access a host-side I/O device, and a virtual machine VM can use a non-virtual device driver as it is. In general, an access of a guest VM to an I/O device is emulated by a hypervisor. On the other hand, a guest VM can perform an I/O access to an I/O device having the passthrough function without via emulation of the hypervisor. In this case, a correlation between the MMIO space of the guest VM and the MMIO space of the host is mapped onto a TDP page table, and the guest VM directly accesses a target I/O device by referring to the TDP page table. When a virtual machine VM executes a read access to an I/O device having the passthrough function, the virtual machine VM directly operates a non-virtual device driver. Thus, a DPC-incompatible device driver is not able to execute appropriate error processing on the ALL “F” data from an I/O device in the abnormal state. The second embodiment solves this problem.

### (3) Related Technologies of Hypervisor Operation

VM_Entry is an operation of transitioning to a VM mode in which a virtual machine VM operates. With VM_Entry, an operation mode transitions to a VM mode from a HV mode in which a hypervisor HV operates. When VM_Entry is executed, the context of the host in the HV mode is saved in the CPU so as to be switched to the context of VM. In the second embodiment, the virtualization-compatible instruction execution unit of the CPU controls VM_Entry.

VM_Exit is an operation of transitioning from a VM mode to a HV mode. In the second embodiment, an operation mode transitions to the HV mode (a control operation by HV) by trapping a specific instruction issued by a guest VM. For example, VM_Exit is executed by trapping an access to an I/O port and a TDP access violation. In a HV mode after VM_Exit occurred, a HV acquires an instruction that caused the VM_Exit and an access destination address by referring to the VM control structure VMCS. Moreover, a guest VM acquires the instruction in execution from an instruction pointer of the guest VM and decodes the instruction using software. In this way, it is possible to understand the state (an access source, an access destination, a transfer size, and the like) of the instruction that caused the VM_Exit. In the second embodiment, the virtualization-compatible instruction execution unit of the CPU controls VM_Exit.

TDP violation occurs when a VM-side physical address is converted to a host-side physical address by referring to the TDP page table and the VM-side physical address is not present in the TDP page table. TDP violation causes a page fault. In the second embodiment, the page fault occurs also when “0” is set to the read access bit in the address of a monitoring target I/O device in the TDP page table. The page fault occurs when the virtualization-compatible memory control unit (MMU) of the CPU performs address conversion by referring to the TDP page table.

(4) Base address register (BAR) is a register in which the address of a register in an I/O device is set. An access to a register in the I/O device is performed on a MMIO space or an I/O space allocated to the memory space.

MMIO is an abbreviation of memory mapped I/O. The MMIO space and the I/O space are programmable and the initialization program of the system sets the MMIO space and the I/O space to the BAR. An access to the I/O device is performed according to the MMIO space and the I/O space. When an access request is issued, an I/O device compares the address set to the BAR and the address in the access request to determine an access destination register.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
an input and output unit to which an input/output device is able to be connected;
an information holding unit that registers identification information of a monitoring target input/output device which is not compatible with an error suppression function of suppressing propagation of errors occurring when the input/output device is disconnected from the input and output unit;
an execution unit that executes an individual program using infrastructure software; and
a determining unit that, by executing the infrastructure software and the individual program, when an access to a first area of the monitoring target input/output device is detected, detects that a value read from a second area of the monitoring target input/output device is an abnormal value as a result of determining whether the value read from the second area is a predetermined value.

2. The information processing device according to claim 1, wherein
the individual program includes a first program that accesses the input/output device, and
the determining unit suppresses an access to the first area when the value read from the second area is the abnormal value.

3. The information processing device according to claim 1, wherein
the infrastructure software includes an operating system and a hypervisor that generates a virtual machine,
the individual program includes a first program that is executed by the virtual machine and accesses the input/output device,
the execution unit generates the virtual machine by executing the infrastructure software, and
the determining unit:
accesses the first area when the virtual machine accesses the first area of the monitoring target input/output device;
accesses the second area when a value read from the first area is the abnormal value; and
stops the virtual machine when the value read from the second area is the abnormal value.

4. The information processing device according to claim 3, wherein
identification information of the monitoring target input/output device is stored in the information holding unit, and
the execution unit, by executing the hypervisor, registers information on the first area of the monitoring target input/output device in the information holding unit in response to an initialization process of the input/output device when the virtual machine is activated.

5. The information processing device according to claim 4, wherein
the information on the first area of the monitoring target input/output device includes an input/output port number of the virtual machine in relation to the monitoring target input/output device, and a conversion table between a first physical page used by the virtual machine and a second physical page used by the operating system.

6. The information processing device according to claim 5, wherein
the execution unit detects the access to the first area of the monitoring target input/output device when converting the first physical page corresponding to the first area of the monitoring target input/output device to the second physical page by referring to the conversion table.

7. The information processing device according to claim 5, wherein
the execution unit enters to a hypervisor mode in response to execution of an access instruction to the input and output device by the virtual machine, and detects the access to the first area of the monitoring target input/output device upon detecting that an input/output port number of the access instruction is identical to the input/output port number in relation to the monitoring target input/output device, included in the information on the first area.

8. The information processing device according to claim 3, wherein
the execution unit stores the value read from the first area in a memory unit of the virtual machine when the value read from the second area is not the abnormal value.

9. The information processing device according to claim 1, wherein
the infrastructure software includes an operating system and a hypervisor that generates a virtual machine,
the individual program includes a first program that is executed by the virtual machine and accesses the input/output device,
the execution unit generates the virtual machine by executing the infrastructure software, and
the determining unit:
accesses the first area when the virtual machine accesses the first area of the monitoring target input/output device;
accesses the second area when a value read from the first area is the abnormal value; and sends a value other than the abnormal value to the virtual machine as a response when the value read from the second area is the abnormal value.

10. A non-transitory computer storage medium that stores therein a control program for an information processing device for causing a processor to operate a process, the information processing device including an input and output unit to which an input/output device is able to be connected, an information holding unit which registers identification information of a monitoring target input/output device which is not compatible with an error suppression function of suppressing propagation of errors occurring when the input/output device is disconnected from the input and output unit and an execution unit which executes an individual program, the process comprising:
determining, when an access to a first area of the monitoring target input/output device is detected, that a value read from a second area of the monitoring target input/output device is an abnormal value as a result of determining whether the value read from the second area is a predetermined value.

11. The non-transitory storage medium according to claim 1, the process further comprising:
generating a virtual machine; wherein
the determining includes,
accessing the first area when the virtual machine accesses the first area of the monitoring target input/output device;
accessing the second area when a value read from the first area is the abnormal value; and
stopping the virtual machine when the value read from the second area is the abnormal value.

12. A method for controlling an information processing device that includes an input and output unit to which an input/output device is able to be connected, an information holding unit which registers identification information of a monitoring target input/output device which is not compatible with an error suppression function of suppressing propagation of errors occurring when the input/output device is disconnected from the input and output unit and an execution unit which executes an individual program, the method comprising:
determining, when an access to a first area of the monitoring target input/output device is detected, that a value read from a second area of the monitoring target input/output device is an abnormal value as a result of determining whether the value read from the second area is a predetermined value.

13. The method for controlling the information processing device according to claim 12, the method further comprising:
generating a virtual machine; wherein
the determining includes,
accessing the first area when the virtual machine accesses the first area of the monitoring target input/output device;
accessing the second area when a value read from the first area is the abnormal value; and
stopping the virtual machine when the value read from the second area is the abnormal value.

14. The method for controlling the information processing device according to claim 13, the method further comprising:
registering information on the first area of the monitoring target input/output device in the information holding unit in response to an initialization process of the input/output device when the virtual machine is activated.

15. The method for controlling the information processing device according to claim 14, wherein
the information on the first area of the monitoring target input/output device includes an input/output port number of the virtual machine in relation to the monitoring target input/output device, and a conversion table between a first physical page used by the virtual machine and a second physical page used by the operating system.

16. The method for controlling the information processing device according to claim 15, the method further comprising:
detecting the access to the first area of the monitoring target input/output device when converting the first physical page corresponding to the first area of the monitoring target input/output device to the second physical page by referring to the conversion table.

17. The method for controlling the information processing device according to claim 15, the method further comprising:
entering to a hypervisor mode in response to execution of an access instruction to the input and output device by the virtual machine; and
detecting the access to the first area of the monitoring target input/output device upon detecting that an input/output port number of the access instruction is identical to the input/output port number in relation to the monitoring target input/output device, included in the information on the first area.
